(19) United States
(12) Patent Application Publication
(10) Pub. No.: US 2015/0186634 A1
(43) Pub. Date: Jul. 2, 2015

(54) BIOMETRIC ACCESS SYSTEM

(71) Applicant: Digit Security, LLC, Irvine, CA (US)

(72) Inventors: Jeffrey L. Crandell, Redondo Beach, CA (US); John M. Shanahan, Newport Beach, CA (US)

(21) Appl. No.: 14/586,556

(22) Filed: Dec. 30, 2014

Related U.S. Application Data
(60) Provisional application No. 61/922,599, filed on Dec. 31, 2013.

(51) Int. Cl. G06F 21/32; H04L 9/32

(52) U.S. Cl. CPC G06F 21/32; H04L 9/3247; H04L 9/3263

(57) ABSTRACT

One or more biometric templates can be stored for a user. The user can access a verification system by scanning biometric data, such as a fingerprint or iris scan, into a biometric reader. A biometric access system can determine whether the scanned biometric data matches one of the biometric templates of the user. If so, then the user may be permitted access to the verification system. The verification system can accept user input from one or more input devices, such as a keyboard, mouse, touchscreen, combinations of the same, or the like. The verification system can programmatically analyze the user input and output one or more reports for presentation to other users.

### INCORPORATION BY REFERENCE TO ANY PRIORITY APPLICATIONS

Any and all applications, if any, for which a foreign or domestic priority claim can be identified in the Application Data Sheet of the present application are hereby incorporated by reference under 37 CFR 1.57.

### BACKGROUND

Authentication can be the verification of a claim about the identity of a person or a system. The information about human physiological and behavioral traits, sometimes referred to as biometric information or simply biometrics, can be used to identify a particular individual with a high degree of certainty and therefore can authenticate this individual by measuring, analyzing, and using these traits. Examples of biometrics include photographs, fingerprints, palm prints, iris scans, audio data, and blood vessel scans. A great variety of specific devices are used to extract and collect biometric information which are referred to hereinafter as biometric scanners.

Using biometric information for identifying individuals may include the steps of biometric enrollment and biometric verification. For example, in the case of fingerprint patterns, a typical biometric enrolment requires acquiring a fingerprint image with a fingerprint scanner, extracting from the fingerprint image information that can be sufficient to identify the user, and storing the extracted information as template biometric information for future comparison with subsequently provided fingerprint images. Several, typically three, images are acquired from the same fingertip for biometric enrolment. A typical biometric verification involves acquiring another subsequent image of the fingertip and extracting from that image information query biometric information which can be then compared with the template biometric information. If the compared information can be sufficiently similar, the result can be deemed to be a biometric match. In this case, the user's identity can be verified positively and the user can be successfully authenticated. If the compared information can be not sufficiently similar, the result can be deemed a biometric on-match, the user's identity can be not verified, and the biometric authentication fails.

### SUMMARY

In certain embodiments, a method of providing biometric access includes (under control of a hardware processor comprising digital logic circuitry) receiving biometric information of a user from a biometric sensor, preprocessing the biometric information to obtain digital biometric data, and comparing the biometric data with a stored biometric template associated with the user to determine whether the biometric data matches the stored biometric template. The method may further include, in response to determining that the biometric data does not match the stored biometric template, denying access to the user. The method may also include, in response to determining that the biometric data does match the stored biometric template, electronically outputting instructions that can electronically generate a graphical user interface comprising functionality for the user to respond to one or more queries, receiving user input from the graphical user interface comprising responses to the one or more queries, generating a report comprising the responses, digitally signing the report with a digital certificate associated with the user, and storing the report and the digital signature in physical computer storage.

The method of the preceding paragraph can be implemented together with any combination of the following features: digitally signing the report further comprises digitally signing the biometric information; where the biometric information includes one or more of the following: a fingerprint, a retinal scan, a palm print, audio data, a finger vein scan, a hand vein scan, a signature, typing recognition, gait information, and a DNA sample; further including receiving the stored biometric template with an embedded browser application; further including extracting the biometric template from a cookie data structure; and further including encrypting the biometric information with a second encryption despite the biometric information already being encrypted.

In certain embodiments, a biometric access system can include a hardware processor comprising digital logic circuitry that can: receive biometric information of a user from a biometric sensor, compare the biometric data with a stored biometric template associated with the user to determine whether the biometric data matches the stored biometric template, identify a match between the biometric data and the stored biometric template, and in response to a match being identified: electronically output a graphical user interface having functionality for the user to respond to one or more queries; receive user input from the graphical user interface comprising responses to the one or more queries, generate a report comprising the responses, and store the report in physical computer storage.

The system of the preceding paragraph can be implemented together with any combination of the following features: the biometric information can include one or more of the following: a fingerprint, an iris scan, a palm print, audio data, and a blood vessel scan; the hardware processor can also receive the stored biometric template with an embedded browser application; the hardware processor can also extract the biometric template from a cookie data structure; the hardware processor can also encrypt the biometric information with a second encryption despite the biometric information already being encrypted; the hardware processor can also digitally sign the report; and the hardware processor can also digitally sign the report together with the biometric information.

In certain embodiments, non-transitory physical computer storage includes instructions stored thereon that, when executed by a hardware processor, can implement a biometric access system that can: receive an indication of whether biometric information of a user matches a stored biometric template, and in response, electronically output a graphical user interface comprising functionality for the user to respond to one or more queries, receive user input from the graphical user interface including responses to the one or more queries, generate a report comprising the responses, and store the report in physical computer storage.

The system of the preceding paragraph can be implemented together with any combination of the following features: the biometric information can include one or more of the following: a fingerprint, an iris scan, a palm print, audio data, and a blood vessel scan; the system can also receive the stored biometric template with an embedded browser application; the system can also extract the biometric template from a cookie data structure; the system can also encrypt the biometric information with a second encryption despite the biometric information already being encrypted; the system can also digitally sign the report; and the system can also digitally sign the report together with the biometric information.

Certain aspects, advantages and novel features of the inventions are described herein. It can be to be understood that not necessarily all such advantages may be achieved in accordance with any particular embodiments disclosed herein. Thus, the inventions disclosed herein may be embodied or carried out in a manner that achieves or selects one advantage or group of advantages as taught herein without necessarily achieving other advantages as may be taught or suggested herein.

### BRIEF DESCRIPTION OF THE DRAWINGS

FIG. 1A is a block diagram illustrating an example biometric access system.

FIG. 1B is a block diagram illustrating an example biometric device and access user interface.

FIG. 1C is a flow diagram of an example recurring reporting process.

FIGS. 2A-B are flow diagrams of example employee notification processes.

FIGS. 3A-B are flow diagrams of example employee registration processes.

FIG. 4 is a flow diagram of an example employee reporting session.

FIG. 5 is a flow diagram of using employee classification to present reports to the employee based on their classification(s) in an embodiment.

FIG. 6 is a flow diagram of using employee classification within a report to present queries(s) related to their classification(s) in an embodiment.

FIG. 7 illustrates asking an employee variations of the same query concept in an embodiment.

FIG. 8 is a flow diagram of an example report submission requiring authentication to file the report in an embodiment.

FIG. 9 is a flow diagram of an example report submission generating a digital signature in an embodiment.

FIG. 10 is a flow diagram of determining employee compliance with a reporting due date in an embodiment.

FIGS. 11A-B are example flow diagrams of filing a report with a biometric template (a) and validating the report with a fingerprint sample (b).

FIGS. 12A-B are example flow diagrams of filing a report using digital audio with a biometric template (a) and validating the report with a fingerprint sample (b).

FIGS. 13A-B are example flow diagrams of filing a report using digital video with a biometric template (a) and validating the report with a fingerprint sample (b).

FIGS. 14A-B are example flow diagrams of embodiments of embedding a biometric template within an image (a) and validating the image with a fingerprint sample (b).

FIGS. 15A-B illustrate asking an employee (a) or employer representative or proper authority (b) to rate the severity of an issue being reported in an embodiment.

FIGS. 16A-B illustrate embedding a web browser within a the client software program (a) and a flow diagram of using an embedded browser with the client and server software programs (b) to provide authorization of biometric credentials in an embodiment.

FIG. 17 is a flow diagram of a method for biometric authentication using web browser cookies as transfer and storage mechanism for biometric template data in an embodiment.

FIGS. 18 through 29 depict example user interfaces that may be generated by the biometric access system.

### DETAILED DESCRIPTION

### I. Introduction

One or more biometric templates can be stored for a user. The user can access a verification system by scanning biometric data, such as a fingerprint, iris or retinal scan, blood vessel scan (e.g., finger vein or hand vein scan), audio/voice scan, a palm print, a signature (e.g., handwritten), typing recognition, gait (walking/running) information, a DNA sample, or the like into a biometric reader. A biometric access system can determine whether the scanned biometric data matches one of the biometric templates of the user. If so, then the user may be permitted access to the verification system. The verification system can accept user input from one or more input devices, such as a keyboard, mouse, touchscreen, combinations of the same, or the like. The verification system can programmatically analyze the user input and output one or more reports for presentation to other users.

In one embodiment, the biometric access system can be implemented in the context of human resources. Employers face an increasingly important challenge of obtaining timely employee workplace activity information. Employee activities while on the job can have undesired consequences, examples include: disruption of the work process, distressing fellow employees, physical or emotional harm to employees, unfair or unlawful treatment of employees or lawsuits. There are many potential desired and undesired employee activities, timely information about which would provide an opportunity for an employer to take action rather than never discovering about the activity or learning about the activity in the future when it may be too late to take effective action. As a result, unwanted activities may go undetected and can cause negative and expensive consequences to the organization, while desired activities may go unrecognized or unrewarded.

Employers attempt to address this situation by employing formal or informal reporting systems. Examples of a formal reporting system would include a paper form or a computer based form to fill out when an employee experiences a situation they have been instructed should be reporting. When an organization has no formal employee activity process employees may choose to report issues verbally, via paper letter, or email.

Current reporting systems fall short of delivering employee activity information to employers, or fail to do so in a timely fashion, often because they are not used by employees experiencing, witnessing, or discovering workplace activates which should be reported. The existing methods require employees to remember the reporting process exists, remember what types of information should be reported, to judge that a particular activity fits the employer's desired threshold for reporting, and to have the desire to take action by proactively reporting an activity instead of ignoring it.

This disclosure describes embodiments of a biometric access system and associated processes for obtaining verified employee workplace activity information. Employees may be required to answer designated queries or questions in the form of an electronic report on a recurring basis. A notice can be sent to employees via email reminding them of the reporting requirement. A user interface can provide a mechanism for validating user credentials and upon validation determines a user's employee classification(s). Further, the biometric access system can also use biometric techniques to validate user credentials. Classification can be used to determine which types of reports and report questions are relevant to the user. Users can then be able to complete those reports they are designated by classification to complete. Questions may also be classification specific and therefore only the questions relevant to the current user's classification(s) are displayed. Some reports and questions may apply to users of any classification. Questions may have triggers which initiate asking additional questions, referred to as child questions, typically to gather detail relevant to the parent question. Questions may also have one or more responses, referred to as indicators, which indicate there can be an issue requiring follow up by appropriate party(s). Upon completion of the report, it can be filed electronically for future reference. If a response in the report meets an issue indicator requirement then the report can be filed with an issue flag set and made available for review by any user authorized to oversee issues for the filing employee. To further facilitate timely action, an email notice can be sent to anyone authorized to oversee issues for the filing employee.

The system may therefore increase opportunities for an organization to discover workplace employee activity information which may otherwise remain unknown forever or until there can be significant business disturbance. The system can implement a process impacting workplace employees and those with human resources (HR), management, and/or legal roles. The system may require employees to file reports about workplace activities on a recurring basis, as opposed to other formalized paper and electronic workplace issue reporting processes or informal processes (e.g. oral, email) which rely on the employee to recall and initiate the reporting process. In one embodiment, employees are asked questions about a topic from multiple perspectives (e.g., personally experienced, or witnessed, or heard about from another person) in order to maximize information discovery opportunities for any particular issue or incident. In order to improve compliance with the recurring reporting schedule, an embodiment notifies employees via email as a reminder of report(s) being due. Reports filed that do not indicate a workplace issue needing resolution or follow up are filed as reported by the employee for future reference. Reports filed that indicate a workplace issue needing resolution or follow up are filed as reported in the computer system, flagged as requiring attention, and with an optional notification to a proper person or persons who have responsibility to address employee issues. An embodiment requires authentication credentials to be provided when submitting the report, not just at system login, in order to further ensure submission can be actually the logged in employee's testimony. In an embodiment authentication can be performed with a biometric device and algorithm.

### II. Biometric System Overview

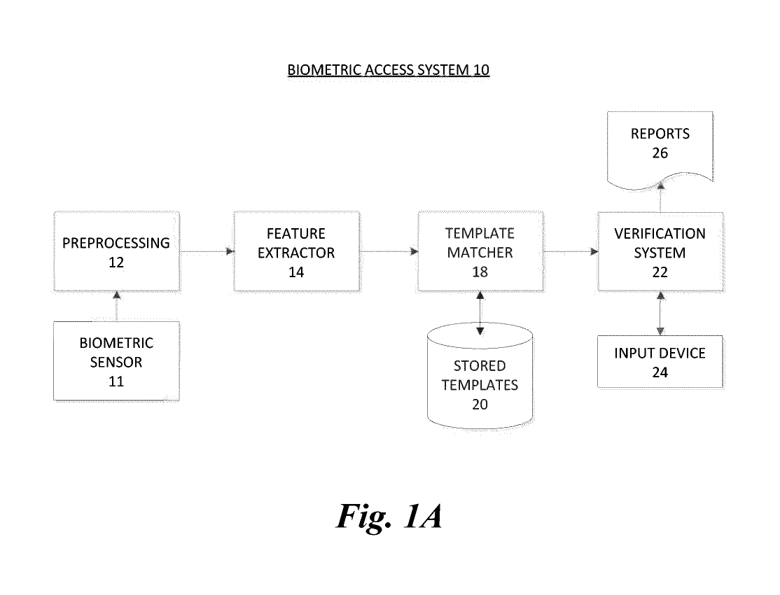

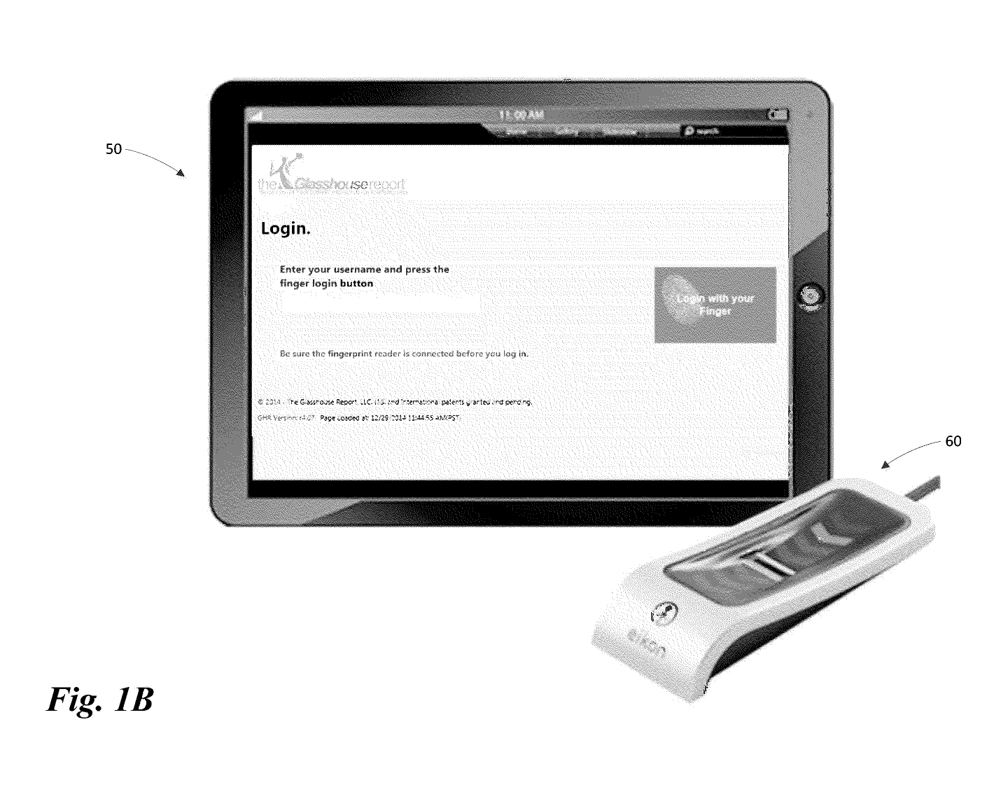

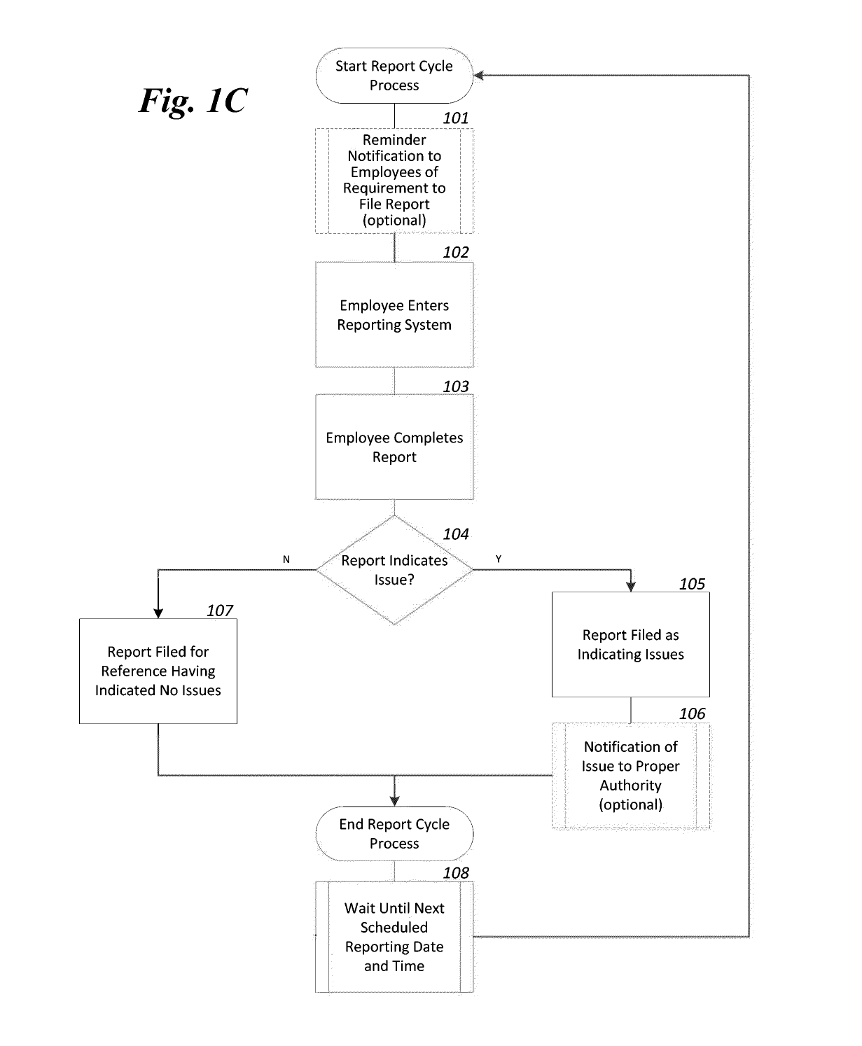

FIG. 1A is a block diagram illustrating an example biometric access system 10. In the biometric access system 10, one or more biometric templates 20 can be stored in physical computer or electronic storage for a user. The user can access a verification system 22 by scanning biometric data, such as a fingerprint or iris scan, into a biometric reader or sensor 11. A preprocessor 12 can format the biometric data appropriately for biometric analysis, for example, by amplifying, applying signal conditioning, and/or analog-to-digital conversion of the sensor data. The output of the preprocessor 12 can be a digital scan of the user's biometric data. For convenience, this digital scan can also be referred to simply as the user's biometric data.

A feature extractor 14 receives the digital scan or biometric data from the preprocessor 12 and extracts features from the biometric data. These features may be indicative of the identity of the user. The biometric access system 10 can determine whether the features match one of the biometric templates 20 of the user. If so, then the user may be permitted access to the verification system 22.

The verification system 22 can be part of a client application and/or server application. For example, the verification system 22 may be a thin client (such as a browser or browser-embedded application, mobile application, or the like) that communicates with a remote server component of the verification system 22. The client application may also implement the feature extractor 14 and template matcher 18. Any client device that is in communication with the biometric sensor 11 or reader can access the verification system 22. The client-facing aspect of the verification system 22, along with the other components shown, can be implemented in any client computing device, such as a desktop, laptop, tablet, mobile phone (e.g., smartphone), smartwatch, e-book reader, kiosk, combinations of the same, or the like. The verification system 22 can accept user input from one or more input devices 24 of the client computing device, such as a keyboard, mouse, touchscreen, combinations of the same, or the like. The verification system 22 can programmatically analyze the user input and output one or more reports 26 for presentation to other users.

The feature extractor 14, template matcher 18, and verification system 22 can be implemented by one or more computer processors or other computer hardware. In an embodiment, the feature extractor 14, template matcher 18, stored templates 20, and/or the verification system 22 can be implemented by one or more physical or virtual servers, which may be physical co-located or dispersed. Thus, for example, the biometric sensor 11 may be implemented at a client device (e.g., connected to a client device of a user) and may communicate with a remote server or servers that implement one or more of the components shown.

In another embodiment, the biometric sensor 11 (and optionally preprocessing block 12) is part of a biometric reader that performs the template matching functionality described above with respect to the template matcher 18. Template matching can therefore be performed by the reader, the client device (e.g., user device), the server, or any combination of the above. In one embodiment, the reader performs template matching by scanning a user's biometric information and receiving a template to compare with the biometric information from a remote server. The reader receives the template in one embodiment based on credentials input into the client device. Once the client device receives the user's credential (such as a username and/or password), the client device can send the credential to the remote server, receive a template corresponding to the user (stored previously in the stored templates 20), and can send the template to the reader. The reader can then compare the stored template with the biometric information scanned by the user to determine whether there is a match. Another option for the reader, client device, or server to perform in one embodiment is to attempt to match the biometric information against all available templates (or at least multiple templates until a match is found). This embodiment does not require the user to first input a credential before a stored template can be compared with the biometric information scanned by the reader.

Furthermore, in certain embodiments, although the reader may encrypt the biometric information obtained from the sensor 11, the verification system 22 or another component at the client device can re-encrypt the biometric information. Applying encryption to the biometric information twice can potentially increase security of the biometric information, particularly in view of the option in some embodiments of transmitting the biometric information over the unsecure Internet to a remote server.

FIG. 1B is a block diagram illustrating an example biometric device 60 and access user interface 50. The biometric device 60 is an example of the biometric sensor 11, and in this example, is a fingerprint reader. The user interface 50 is implemented in a computing device, which in this example is a table computer. The user interface 50 requests a user to log in by scanning biometric data into the biometric device 50. Once the user has logged in, the user can access the verification system 22 implemented on the tablet computer or implemented on a remote server and accessed by the tablet computer.

### III. Example Processes

Each of the example processes described below can be implemented by the biometric access system 10 and/or verification system 22 described above or by another computing system comprising computer hardware. This computer system may, but need not, include any biometric functionality. For convenience, subsequent references to “the system” herein may refer to the biometric access system 10, the verification system 22, another computer system, or all three. References to embodiments refer to embodiments implemented by the system, even if not explicitly so stated.

FIG. 1C is a flow diagram of a recurring reporting process in one embodiment. Employee users of the system may be required to file workplace activity reports on a recurring basis, according to a defined schedule. In an embodiment of the system, optionally a reminder can be sent 101 to employees regarding the report due date in order to improve compliance. The employee enters the reporting system 102 and completes a report 103 by answering one or more question(s) presented. Questions can include items presented to the employee that may request a response in the form of computer based input mechanisms, for example text, drop down selection box, radio buttons, multiple choice, true/false, yes/no (Y/N), or an affirmation button. Other embodiments may implement digital audio or video input or any other useful employee input mechanism. Upon completion, the application reviews the employee response(s) for issue indicators 104, which may include response content having been defined to indicate workplace activity issues requiring follow up review and potentially other action. If issues are indicated, the report can be filed with a flag indicating it has issues 105. An embodiment of the system may have multiple issue indication flags used to specify the nature or severity of the issue indicated by the employee input.

An embodiment of the system optionally notifies a designated person(s) who have proper authority to review employee reports 106. Otherwise, a report with no issue indication can be filed with employee responses 107 and available to designated person(s) having proper authority for review. An embodiment can use any notification mechanism implemented with the system (such as text, email, instant messaging, automated phone calling, etc.). An embodiment may designate that one or more authoritative person(s) may review reports for a subset of the total employee group contained in the system. After the reporting is complete, the next report can be due at some future point scheduled as the next reporting deadline. This reporting cycle can be made known to employees and they wait until the required reporting period expires before submitting their next report 108.

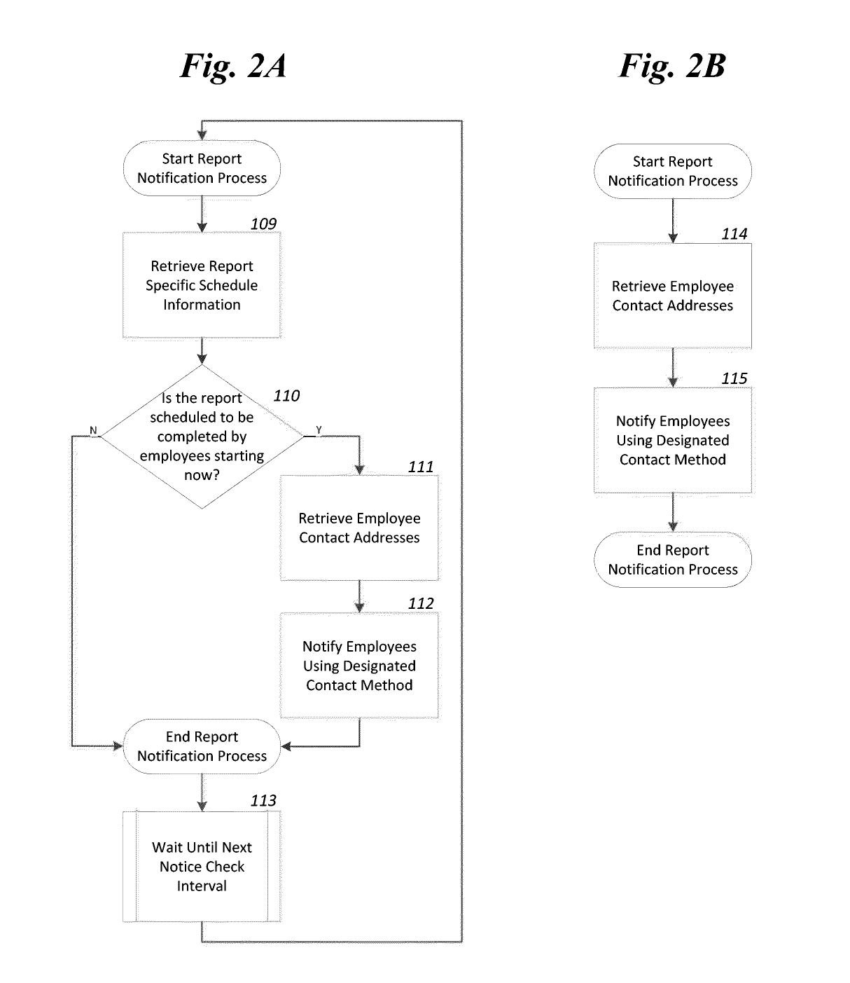

FIGS. 2A-B are flow diagrams of employee notification processes in embodiments of the system. In FIG. 2A, the notification process can be automated via a scheduling mechanism of the system in an embodiment. The mechanism retrieves report schedule information for due dates and times 109 and determines if a reminder should be sent by comparing current date and time with the scheduled reporting start date/time 110. If the start date and time has been reached, employee contact addresses related to the notification mechanism are retrieved 111 and employees are notified using the notification mechanism(s) integrated with the system 112. When notification can be complete, the system waits for the next defined notice interval 113 to check the requirement for notification.

In FIG. 2B, the notification process of an embodiment may be triggered manually or via a third party scheduling system or external application. Once triggered manually by a user (i.e., by pressing a button in the system) or by the external application, employee contact addresses related to the notification mechanism are retrieved 114 and employees are notified using the notification mechanism(s) integrated with the system 115. In an embodiment, email can be used to send notifications. In other embodiments, it may be advantageous to use other mechanisms of notification either singularly or in combination, e.g., text (SMS) message, automated telephone call, posting to private web page or public web page, or any other application where employees can receive content. An embodiment of the system may also allow designation of notification mechanism by employee or employee groups. Other embodiments may include the utility for multiple notification reminders spanning from timeframes prior to the due date, on the due date, and after the due date.

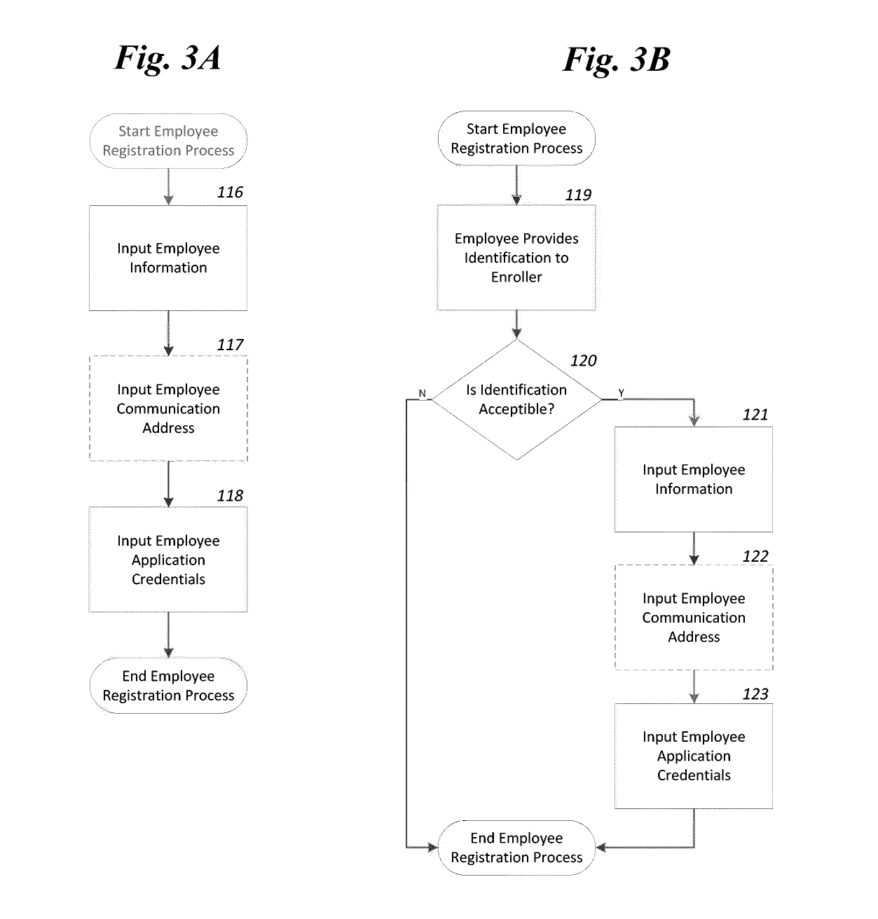

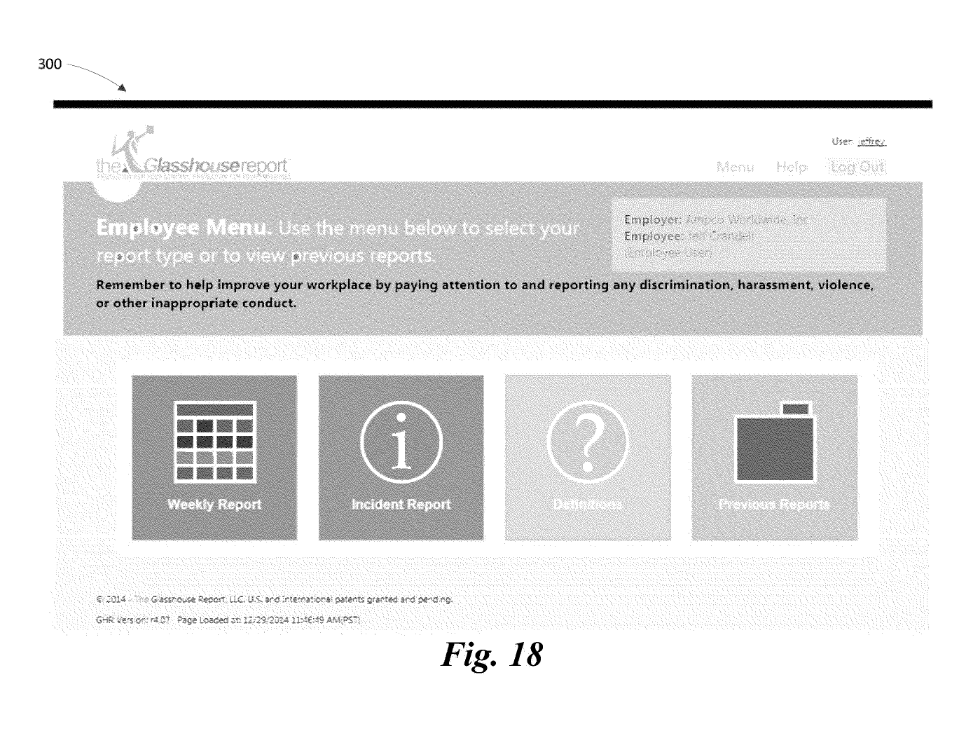

FIGS. 3A-B are flow diagrams of employee registration processes in embodiments of the system. In FIG. 3A, employee information such as name, employee identification number, department, etc. are entered into the system in an embodiment 116. An embodiment may request some data element to identify the employee within the data stored for all employees. An embodiment may optionally provide input for employee communication addresses to be used in notifications 117. Credentials can also be created in the application 118 so that the user can be authenticated to access the application and potentially to be used for authentication and signing of reports depending on the specific requirements of an embodiment. The application is one example of the system, or a client-facing user interface output by the system (see, e.g., FIGS. 1B, 18).

In FIG. 3B, an employee provides identification to a person enrolling employees into the system 119 in an embodiment. Because initial verification of identity reduces the possibility of fraudulent report submission, embodiments may employ one or more methods for identification, e.g., visual, driver's license, employee badge, external computer system based authentication, etc.

The identification can be evaluated 120 and if found acceptable, employee information such as name, employee identification number, department, etc. are entered into the system in an embodiment 121. An embodiment of the system would require some data element to identify the employee within the data stored for all employees. An embodiment of the system may optionally provide input for employee communication addresses to be used in notifications 122. Credentials are also input in the application 123 so that the user can be authenticated to access the application and potentially to be used for authentication and signing of reports depending on the specific requirements of an embodiment. Some embodiments may use an outside authentication mechanism, therefore in one embodiment negating the need for credentials specific to the application system in the designated steps of FIGS. 3A-B.

An embodiment of the system may use employee classification as a mechanism to display different reports and report questions to employees based on applicability to their function, position, or other workplace factor. The classification information may be entered with the employee information as instructed in FIGS. 3A-B.

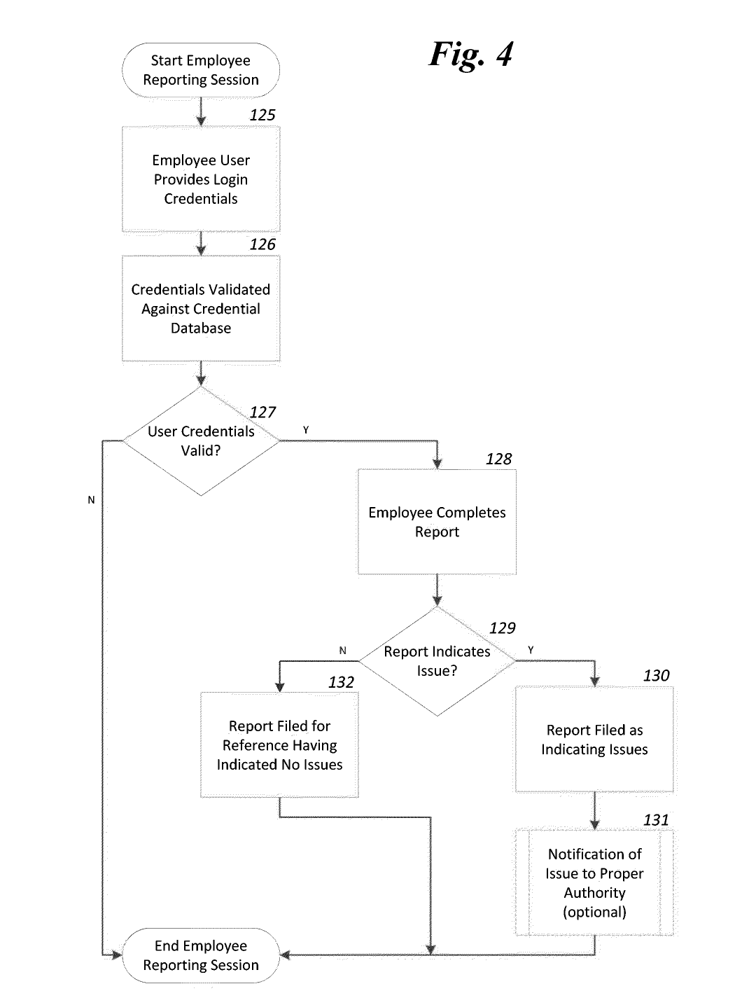

FIG. 4 is a flow diagram of an employee reporting session in an embodiment. To enter the system, an employee can provide login credentials 125 as appropriate to the authentication mechanism of the embodiment. Credentials in computer system applications typically include a user identifier and a secret password, but in more secure embodiments may include: required prompts and responses, multi-factor mechanisms such can be digital codes produced by a device or other computer system, a personal identification number (PIN), biometric verification, combinations of the same, or the like. In an embodiment, a username and fingerprint biometric reader provide authentication. Embodiments of the system may use any authentication mechanism to enter the system, including external authentication systems integrated into the system.

Credentials may be validated against a credential store database 126 or with an external authentication system in some embodiments. If the credentials are determined valid 127, the employee can be enabled to complete one or more reports. Upon completing a report 128, issue indicators are evaluated 129 and a report can be filed indicating issues 130 and optionally notification to proper authority sent 131, or not containing issues 132, as described above with respect to FIGS. 1 and 2A-B.

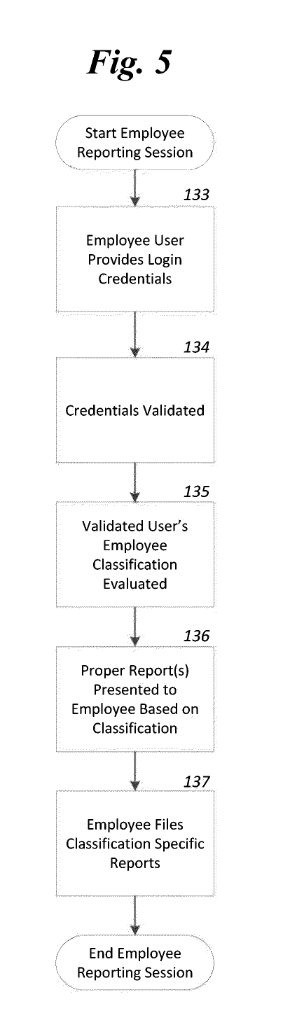

FIG. 5 is a flow diagram of using employee classification to present reports to the employee based on their classification(s) in an embodiment. An employee provides credentials at login 133, and upon validation 134, the employee classification are evaluated. Based on the employee classification, zero or more reports may be presented to the employee for completion 136. An embodiment may provide for multiple classifications per employee which combine to present an appropriate set of reports to complete. An embodiment also allows for a report to be assigned to all employees regardless of classification. Similar functionality could be achieved in another embodiment by creating a classification that all employees are assigned to. Upon presentation of the classification appropriate report(s) employees are able to file the report(s) 137.

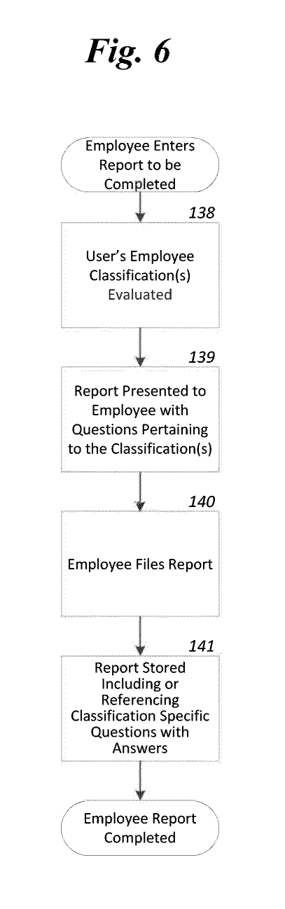

FIG. 6 is a flow diagram of using employee classification within a report to present the question(s) related to their classification(s) in an embodiment. Upon entering a report to complete, an employee's classification can be evaluated 138. The system then compares classification(s) of the employee with those of each question and presents (in an embodiment) only those questions sharing one or more of the employee's classifications 139. Implementing this capability within an embodiment relies on questions being defined as related with one or more employee classifications within the system. Upon filing a report 140, the report can be stored in the system with the questions actually presented to the employee as a result of their classification 141.

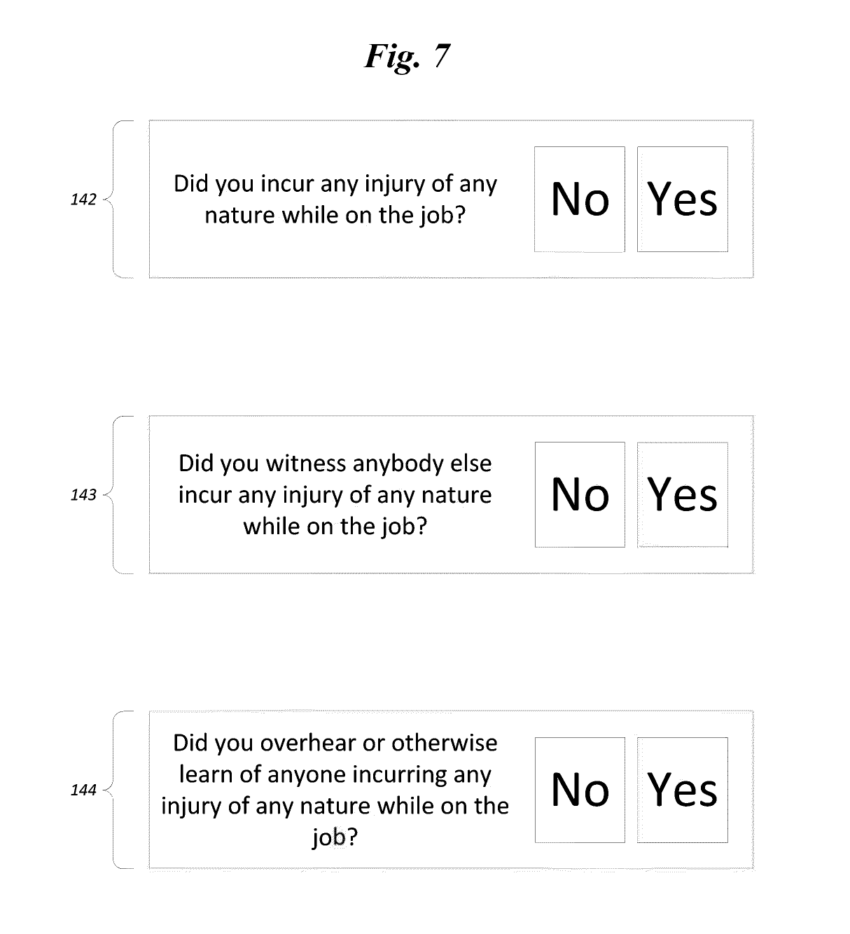

FIG. 7 illustrates example portions of a user interface that may be output by the system and which ask an employee variations of the same question concept in an embodiment. Presentation of questions which not only inquire about incidents that happened personally to the employee, but also include those they witnessed or otherwise became aware of can improve the discovery of workplace information and confirmation of reports provided by other employees about the same incident. Employees may be asked if something specific happened with their direct involvement as in 142 which inquires if the employee incurred an injury on the job. Employees may be asked if they witnessed something happening with others involved as in 143 which inquires if the employee witnessed anyone else incurring an injury on the job. User interface controls (such as buttons for “no” and yes”) are also provided for receiving user input. These user interface controls may be varied in other embodiments, as described below with respect to FIG. 18.

Employees may be asked by the system if they overheard or otherwise learned of something specific happening with others involved as in 144 which inquires if the employee learned of anyone incurring an injury via any other means. In this regard an embodiment can be increasing discovery of workplace activity information by requiring responses which do not only include incidents in which employees were directly involved, but include opportunities to discover hearsay, or second-hand information such as finding out by reading an email, viewing a report or other data, seeing a photo, or seeing or hearing a recording. An embodiment uses this method to improve discovery and to obtain corroboration of employee reports.

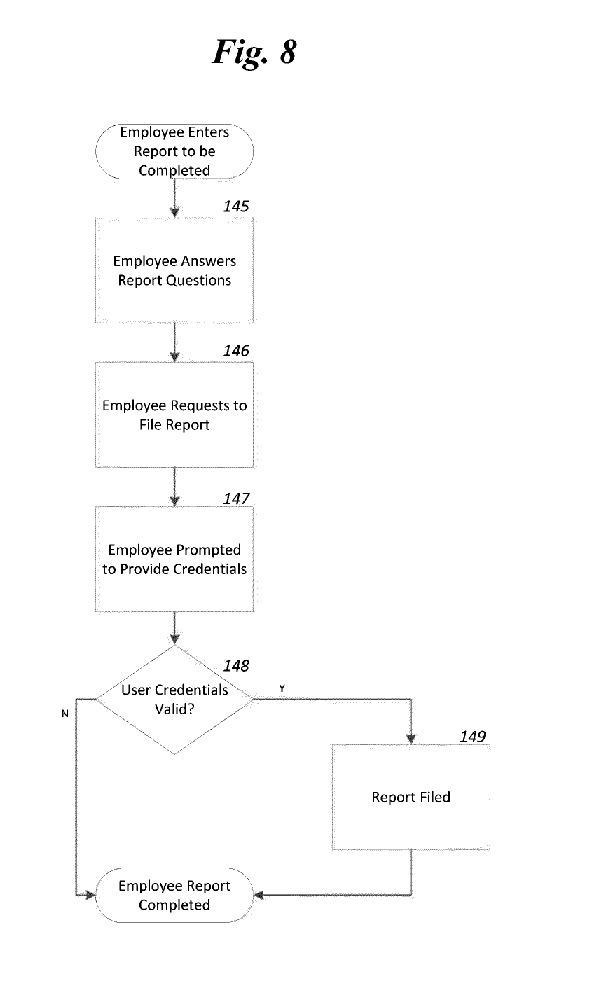

FIG. 8 is a flow diagram of a report submission requesting authentication to file the report in an embodiment. An employee enters a report and answers questions according to the method of the system 145. Upon completion of responses to questions, the employee may select to file the report 146, and can be subsequently prompted for their credentials 147. After providing credentials, they are validated 148 by the system using the credential mechanism of the embodiment (such as biometric verification, username/password, challenge-response, etc.). If credentials are valid 148, the report can be filed 149. If not the report submission may fail at which point an embodiment may allow for the employee to retry providing credentials.

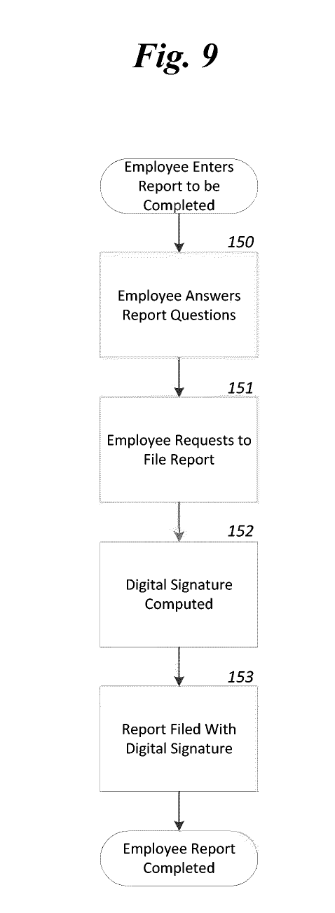

FIG. 9 is a flow diagram of a report submission generating a digital signature in an embodiment. Digital signatures may be used in an embodiment in order to ensure the integrity of report data, for authentication of the filing employee of a report, and to reduce non-repudiation. For example, a digital certificate of an employee can be used by the system (e.g., transparently to the employee) to digitally sign a report submitted by an employee. The resulting report may include the report concatenated with the digital signature. There are multiple mechanisms used in practice for creating digital signatures. Examples of commonly used algorithms include Diffie-Hellman and RSA. An employee enters a report and answers questions 150. When complete the employee selects to file the report 151. A digital signature can be computed for the report content 152 using the employee's signing key as employed by the implemented digital signature algorithm and then filed with the report 153. An embodiment using any valid standard or non-standard digital signature mechanism can digitally sign an employee report for the uses described above.

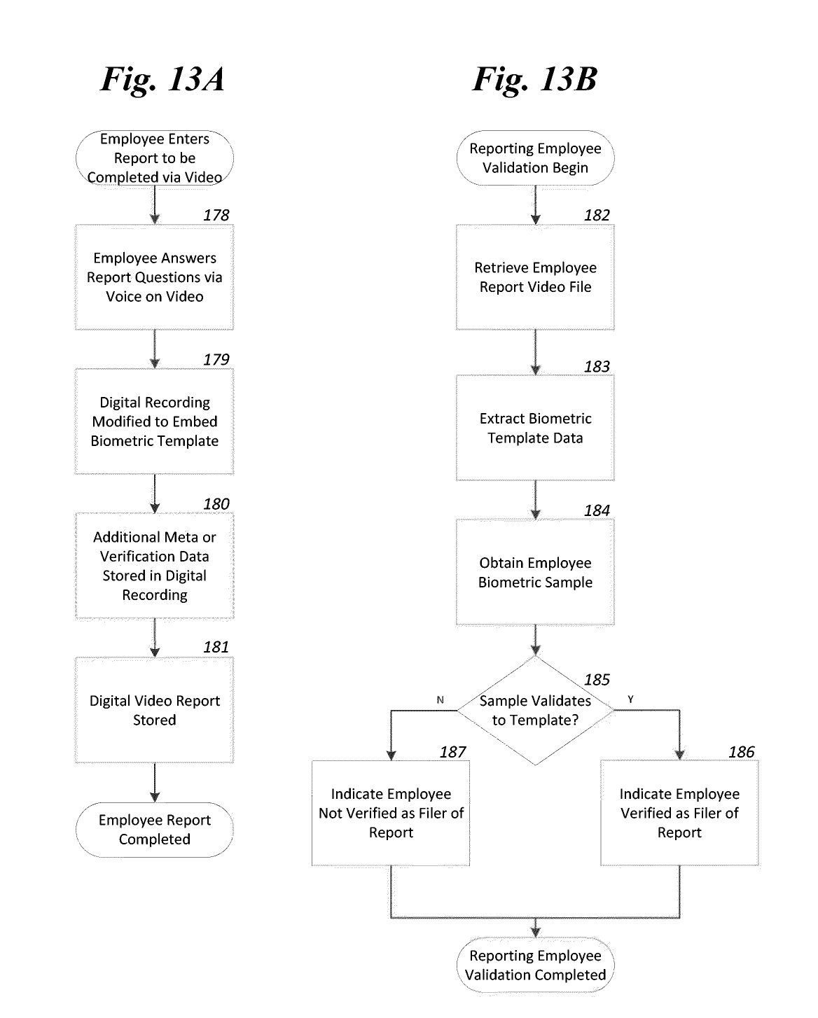

In an embodiment, the employee's biometric information may be concatenated with the report prior to digitally signing the report. Thus, for example, the system may digitally sign both the biometric information and the report together. The system may also apply the digital signature to other information or data submitted with the report, such as video (see, e.g., FIG. 13, described below).

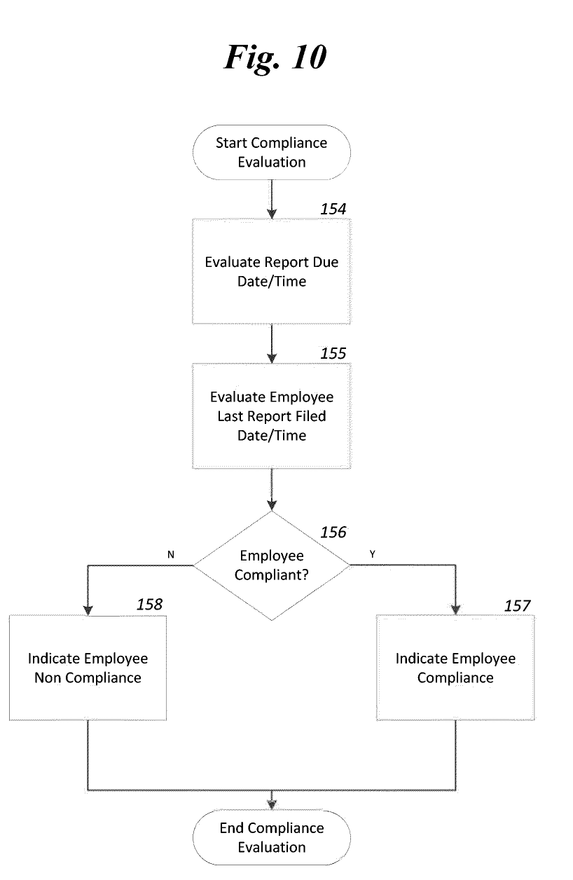

FIG. 10 is a flow diagram of determining employee compliance with a reporting due date in an embodiment. Within the system, reports may be defined with a due date or a reporting cycle which when calculated determines a due date. The recurring nature of report filing in the method of the system can be useful in order to increase discovery, audit trail of reported workplace activities (or lack thereof), and to establish historical profiles of employees and incidents. To ensure or attempt to ensure the most complete information can be obtained from employees, it can be useful to increase participation in the reporting process. An embodiment provides employee compliance information to help employers be informed of compliance so that they may take action in cases where employees are not compliant. In evaluating compliance, a report's due date and time are evaluated 154 and compared to the last time a particular employee filed that report 155. However, an administrator of the system can override the compliance requirement for one or more employees who are in trusted positions (or positions designated for not requiring compliance), or for employees who are out of the office (e.g., on vacation).

If the employee has filed a report since the due date 156, the output may indicate that the employee can be currently compliant 157. If the employee has not filed the report since its due date, the output may indicate that the employee is currently not compliant 158. An embodiment of the system may implement this method to evaluate a single employee or all employees, or a subset as required and may evaluation compliance on one report or on multiple reports. Another embodiment of the system may provide an indicator of reports that were filed late but that are now currently compliant.

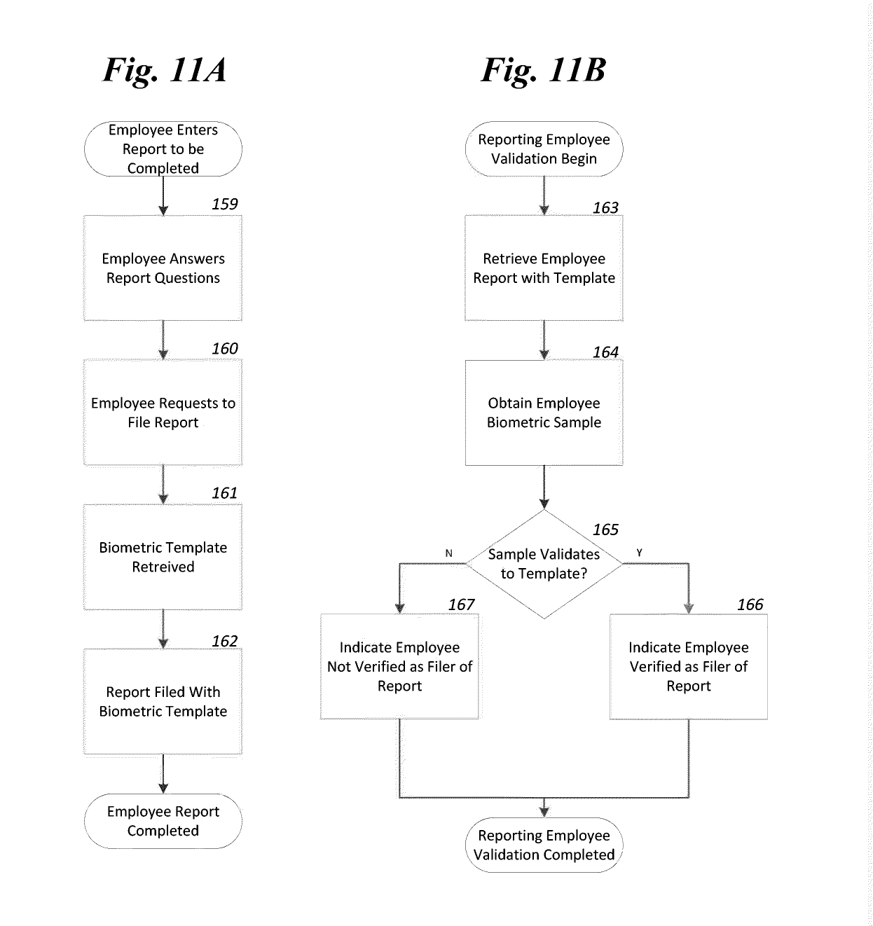

FIGS. 11A-B are flow diagrams of filing a report with a biometric template (a) and validating the report with a fingerprint sample (b) in an embodiment. Biometrics are useful to verify identity, authenticate access, and for digital signatures. A biometric template can be a representation of one or more biometrics in a digital format which can be used to verify a sample of a biometric. In an embodiment, the biometric template may be stored with an employee filed report. This could be useful in a variety of situations e.g., if the report is required to be validated after a template has been removed or changed in its primary biometric management system, or if an embodiment requires a report to be validated outside of the system.

In FIG. 11A, an employee enters a report to be completed and answers report questions 159. When the employee requests to file the report 160, a copy of the biometric template of the filing employee can be retrieved from its source 161 and then stored with the report 162 where it can later be matched against a sample of an employee biometric for validation. In FIG. 11B, a report to be validated can be retrieved 163 and a sample of an employee biometric obtained 164. The sample and template are compared according to the biometric mechanism employed. If the biometric sample validates to the template 165 an indication presented that the sample and its source (the employee providing the sample) can be indicated as the original filer of the report 166. If the sample does not validate to the template, an indication can be presented that the sample does not validate against the original filer's biometric template 167.

In another embodiment, a new biometric template could be created at the time of report filing by sampling the employee biometric and that template stored with the report. In another embodiment, a sample biometric could be validated against the stored biometric, and when validated, the sample data stored with the report for potential future validation against the template.

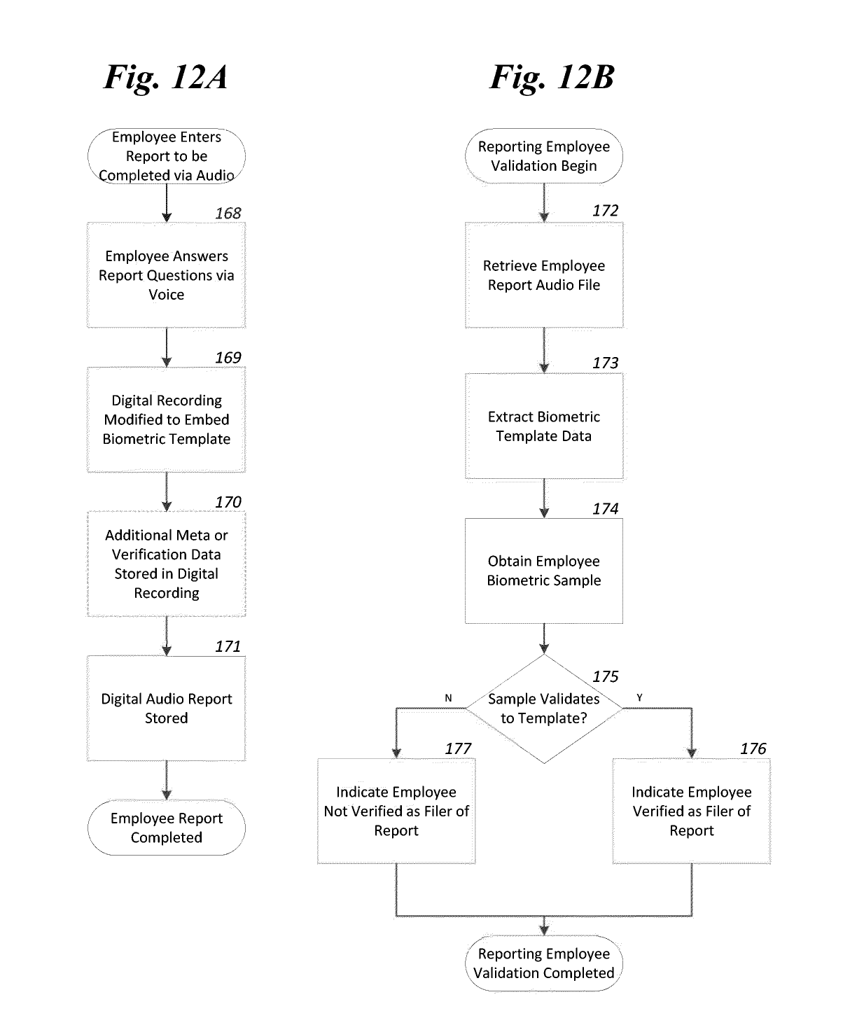

FIGS. 12A-B are flow diagrams of filing a report using digital audio with a biometric template (a) and validating the report with a fingerprint sample (b) in an embodiment. As in FIGS. 11A-B, biometrics may be a useful tool for validating a filer of a report stored within or separated from the system. In an embodiment, an employee report may be filed in whole or in part as digital audio. Some digital audio formats include in their specification the ability to store additional data within the file or data stream. MP3 files, for example, use the EXIF standard metadata capabilities allowing for additional text or binary data to accompany the file or data stream. In FIG. 12A, an employee answers report questions via digital audio recording 168 in an embodiment. The digital audio data can be then modified to add the biometric template 169, or an encoded adaptation of same, within a segment of the file or data stream made available by its digital audio specification.

Optionally an embodiment may add additional metadata regarding the report or validation data to the digital recording 170, and then the recording can be stored 171 or potentially streamed. In FIG. 12B, an audio report to be validated can be retrieved 172 and the biometric template extracted 173. A sample of an employee biometric can be obtained 174. The sample and template can be compared according to the biometric mechanism employed. If the biometric sample validates to the template 175, an indication presented that the sample and its source (the employee providing the sample) can be indicated as the original filer of the report 176. If the sample does not validate to the template, an indication can be presented that the sample does not validate against the original filer's biometric 177.

In another embodiment, a new biometric template could be created at the time of report filing by sampling the employee biometric and that template stored with the report. In another embodiment, a sample biometric could be validated against the stored biometric, and when validated, the sample data stored with the report for potential future validation against the template. In another embodiment, the biometric template data may be stored within the recorded audio data. This may produce distortion in the audio but may be useful if other mechanisms are not available.

FIGS. 13A-B are flow diagrams of filing a report using digital video with a biometric template (a) and validating the report with a fingerprint sample (b) in an embodiment. As in FIGS. 11A-B, biometrics can be a useful tool for validating a filer of a report stored within or separated from the system. In an embodiment, an employee report may be filed in whole or part as digital video. Some digital video formats include in their specification the ability to store additional data within the file or data stream. In FIG. 13A, an employee answers report questions via digital video recording 178 in an embodiment. The digital video data can be then modified to add the biometric template 179, or an encoded adaptation of same, within a segment of the file or data stream made available by its digital video specification.

Optionally an embodiment may add additional metadata regarding the report or validation data to the digital recording 180, and then the recording can be stored 181 or potentially streamed. In FIG. 13B, a video report to be validated can be retrieved 182 and the biometric template extracted 183. A sample of an employee biometric obtained can be 184. The sample and template can be compared according to the biometric mechanism employed. If the biometric sample validates to the template 185 an indication presented that the sample and its source, the employee providing the sample, can be indicated as the original filer of the report 186. If the sample does not validate to the template, an indication can be presented that the sample does not validate against the original filer's biometric 187.

In another embodiment, a new biometric template could be created at the time of report filing by sampling the employee biometric and that template stored with the report. In another embodiment, a sample biometric could be validated against the stored biometric, and when validated, the sample data stored with the report for potential future validation against the template. In another embodiment, the biometric template data may be stored within the recorded video data. This would produce distortion in the video but may be useful if other mechanisms are not available.

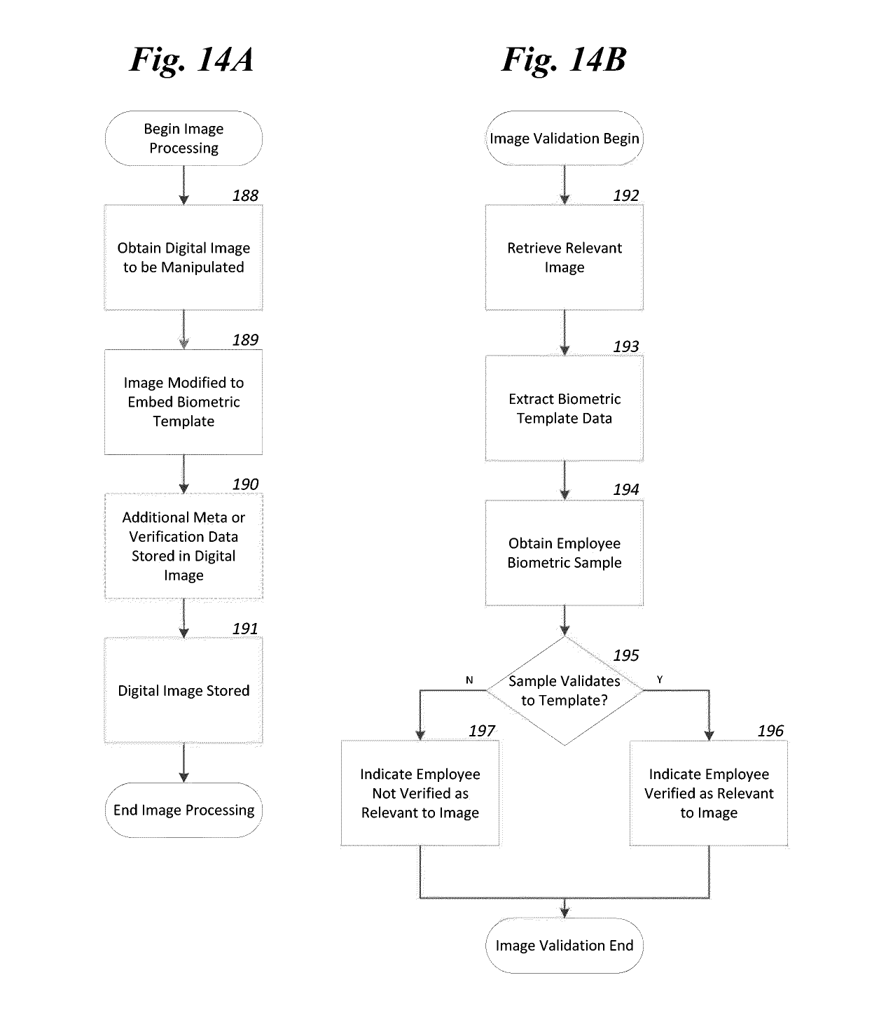

FIGS. 14A-B are flow diagrams of embedding a biometric template within an image (a) and validating the image with a fingerprint sample (b). Embedding biometric template data into an image component of a report, or a digital image of the report, may be useful in some embodiments. An image modified in such a manner could be transported electronically and potentially validation outside of the original system in which it originated. It could also be used to validate that images related to a report have not been modified. Many image types support the EXIF specification, which provides data elements to embed data. In FIG. 14A, a digital image can be obtained 188. The image can be modified according to its specifications to include a biometric template 189, or an encoded adaptation of same.

Optionally an embodiment may add additional metadata regarding the report or validation data to the digital recording 190. The image can be then stored 191. In FIG. 14B, an image be validated against a biometric can be retrieved 192 and the biometric template extracted 193. A sample of a biometric can be obtained 194. The sample and template may be compared according to the biometric mechanism employed. If the biometric sample validates to the template 195 an indication presented that the sample and its source, the person providing the sample, can be indicated as the same as the originator of the template stored with of the image 196. If the sample does not validate to the template, an indication can be presented that the sample does not validate against the original template's biometric 197.

In another embodiment, a new biometric template could be created at the time of image modification by sampling the employee biometric and that template stored with the image. In another embodiment, a sample biometric could be validated against the stored biometric, and when validated, the sample data stored with the image for potential future validation against the template. In another embodiment, the biometric template data may be stored within the image data content. This would produce distortion in the image but may be useful if other mechanisms are not available. Another embodiment could use audio, video, or other multimedia, types embedded with a biometric template as additional components of a non-media or other media employee report.

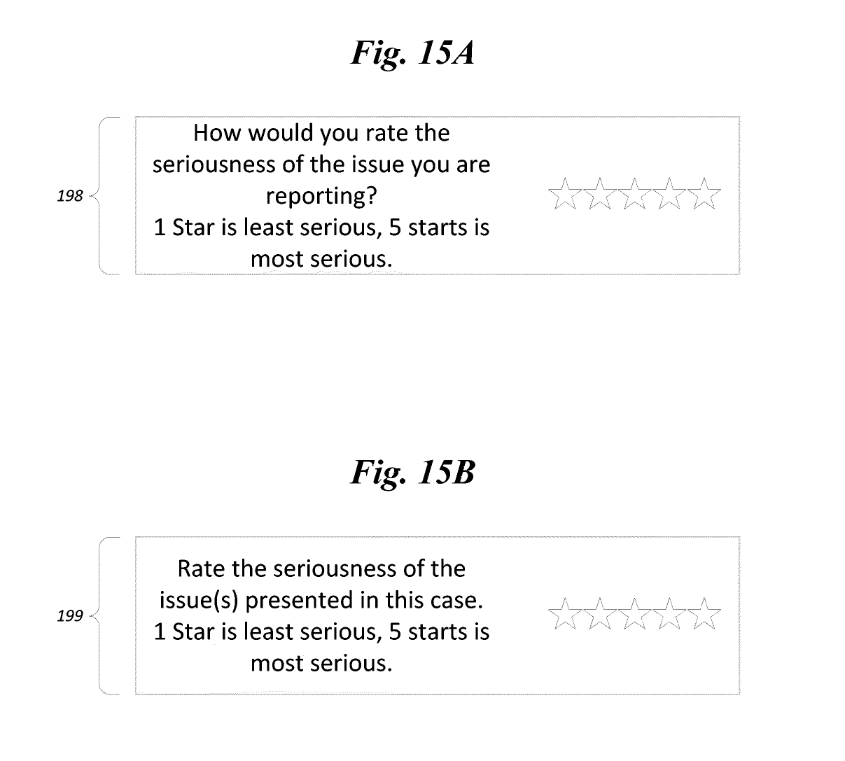

FIGS. 15A-B illustrate asking an employee (a) or employer representative or proper authority (b) to rate the severity of an issue being reported in an embodiment. In such an embodiment it may be useful to gauge the severity, importance, damage, potential consequences, potential monetary value, or other opinion or factual information about a report outside of the report description itself. This report metadata may be stored for future analysis as relates to the report or may be used for sorting or filtering purposes when displaying report summary or detail data on a computer screen or output to a document. It may also be useful in some embodiments in order to determine which reports with issues should receive priority when responsive action can be needed.

It may also be useful in some embodiments to compare the employee's rating of a particular factor to the proper authority's rating. In FIG. 15A, an employee can be prompted to rate the seriousness of an issue he is reporting 198. In an embodiment, the employee may input their rating using a star rating input mechanism 198 in which the employee selects the number of stars (or other indication of rating) indicating seriousness, wherein the star visual elements would visually indicate selection by changing color, size, transparency or other visible property. Other embodiments may use a numeric input or selection to represent the same rating, or a textual input or selection to indicate seriousness. Embodiments of the system may use any variety of input mechanisms that allow for input of a range of values.

The provided rating may be stored with or related to the report so that further utility can be derived from it. Embodiments may collect one or more rating or ranged inputs related to a report and one or more ratings may be mandatory. In FIG. 15B, an employer representative or proper authority can be prompted to rate the seriousness of an issue 199 which has been reported by an employee of an organization in an embodiment. In an embodiment, the employer representative or proper authority may input his or her rating using a star rating input mechanism 199 in which the user selects the number of stars (or other rating indicators) indicating seriousness wherein the star visual elements would visually indicate selection by changing color, size, transparency or other visible property. Other embodiments may use a numeric input or selection to represent the same rating, or a textual input or selection to indicate seriousness. Embodiments of the system may use any variety of input mechanisms that allow for input of a range of values. The provided rating may be stored with or related to the report so that further utility can be derived from it. Embodiments may collect one or more rating or ranged inputs related to a report and one or more ratings may be mandatory.

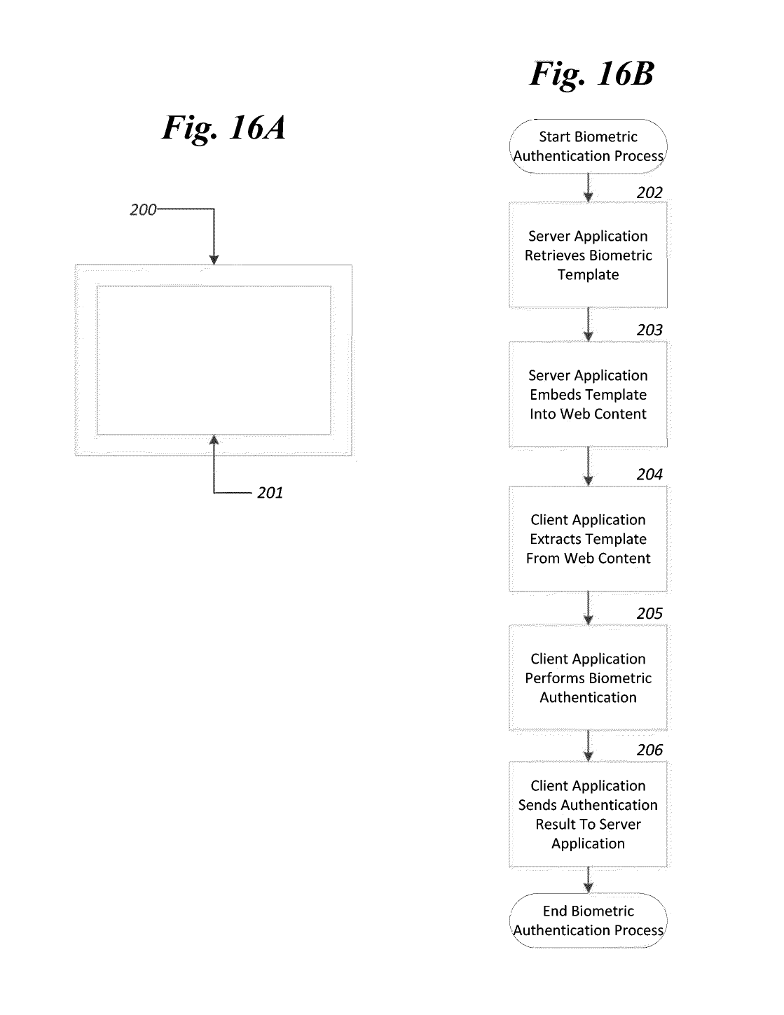

FIGS. 16A-B illustrate embedding a web browser within the client software program of the system (a) and a flow diagram of using an embedded (or separate) browser with the client and server software programs of the system (b) to provide authorization of biometric credentials in an embodiment. Embedding web browser functionality into client software programs can allow using the standardized web client/server mechanism as a primary or secondary user interface created and transferred from a web server. In FIG. 16A, a web browser has been embedded into the client software program of the system 200.

The system may have one or more code libraries either within its software development platform or available as an add-on to such platform. In some cases, a developer may be able to use an application programming interface (API) to embed a browser that has been previously installed in the client computer or that can be included in the client computer's operating system. Alternately a developer may create his own web standards-compliant web browser functionality within the client application or as a standalone library. The embedded browser 201 may be visible in user interface of the client software in any possible amount of size available, from the entire interface or any fraction of the interface as desired, or possibly completely invisible. An embedded browser which can be completely hidden from the user interface can be used as a data transport mechanism instead of a display of web server generated content. Similarly, the client software program of the system 200 may have any variety of visible user interface elements, including having no interface visibility.

In FIG. 16B, the web server application retrieves a biometric template for a user to be authenticated from a data store 202. The server application, as a normal method in web server applications, can add content to a web page as it is generated 203 and before being sent to the web browser client. There may be a plurality of options for transferring data elements not intended for display in the browser. In one embodiment, the biometric template can be stored within a standard HTML “input” tag designated as “hidden” with a value set as the template. Biometric template data may be converted by the system to a data type that can be transferred as the character set supported by the web browser according to the web specification employed by the browser and the web server.

An embodiment of the system may add biometric template data to the web content generated by the web server without using HTML or other web standard mechanisms. In such an embodiment, the client program can detect and extract and remove the template data from the server generated content prior any rendering of the otherwise standards compliant content. After insertion of the biometric template data into the generated web content, the web content can be transferred to the web browser component embedded into the client software of the system. Upon receiving web content from the web server, the client program can extract the biometric template data 204 either from a standard web content element or from a non-standard custom data method created for such a purpose. Using the extracted biometric template, the client application can perform a biometric authentication 205 according to the methods employed by the specific biometric being used.

An embodiment could transfer and use multiple biometric templates of either the same or a variety of biometric types in order to sample and authenticate multiple biometrics, sometimes referred to as multimodal. After performing biometric authentication 205, the result of the authentication can be sent to the web server application 206 using either standard web browser to web server data transport mechanisms such as HTTP GET, HTTP POST, or hidden input data value, or using a non-standard method which the web server application has been programmed to support. Upon receipt and detection of the authentication result, the web server application can take the desired action according to the result.

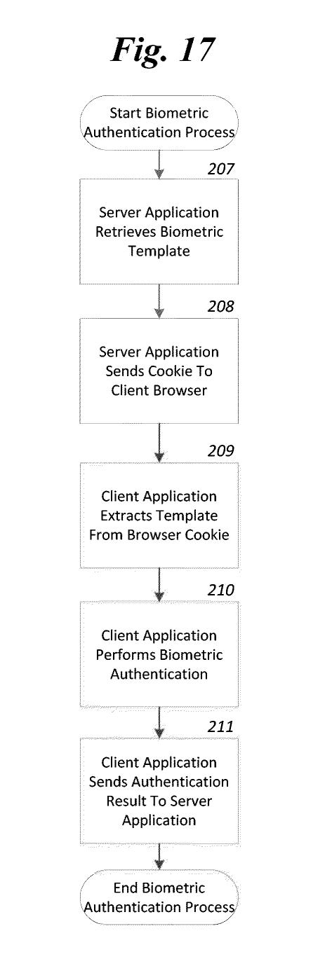

FIG. 17 is a flow diagram of a method for biometric authentication using web browser cookies as transfer and storage mechanism for biometric template data in an embodiment. The web server application retrieves a biometric template for a user to be authenticated from a data store 207. The server application can add special data structures called cookies to the content sent to a web browser. In an embodiment, the server application creates a cookie according to web standards for content format and data encoding 208 and sends the cookie to a client web browser (e.g., implemented in the client computing device described above with respect to FIG. 1A).

A client program, which may have the client web browser embedded into itself as in FIG. 16A, or which may run independently of the web browser running on the client computer, extracts the biometric template from the cookie content 209 sent by the web server. The method of cookie extraction can vary based on the web browser implemented on the client and according to the development tools available to the programmer. For example, some web browsers store cookies as plain text files which can be opened and read directly, while others have a database which can be queried using database access methods or designated application program interface (API), while still others may implement a proprietary mechanism.

Using the extracted biometric template, the client application can perform a biometric authentication 210 according to the methods employed by the specific biometric being used. An embodiment could transfer and use multiple biometric templates of either the same or a variety of biometric types in order to sample and authenticate multiple biometrics, sometimes referred to as multimodal. After performing biometric authentication 210, the result of the authentication can be sent to the web server application 211 using either standard web browser to web server data transport mechanisms such as GET, POST, or hidden input data value, or using a non-standard method which the web server application has been programmed to support. Upon receipt and detection of the authentication result the web server application can take the desired action according to the result.

Advantageously, in certain embodiments, performing biometric authentication using an embedded browser can increase the ease of adding biometric authentication functionality to an application because well-vetted, off-the-shelf back-end authentication tools exist that communicate natively with browser data. The embedded browser approach can therefore be used to more easily add-on any of the biometric authentication features described herein to any application not natively designed for biometric authentication, including mobile applications.

### IV. Additional Example User Interfaces

FIGS. 18 through 29 depict example user interfaces that may be generated by the biometric access system. The user interfaces are merely examples that illustrate some example embodiments described herein and may be varied in other embodiments. For instance, user interface controls shown may include buttons, checkboxes, radio buttons, and the like, any of which may be altered to include any other type of user interface control including, but not limited to, checkboxes, radio buttons, select boxes, dropdown boxes, textboxes or any combination of the same. Likewise, the different user interface controls may be combined or their functionality may be spread apart amongst additional controls while retaining the similar or same functionality as shown and described herein with respect to FIGS. 18 through 29.

FIG. 18 depicts an example reporting user interface 300. In the example user interface 300 shown, user interface controls are provided for accessing a weekly report, an incident report, and previous reports. Each report may be generated as described above. The user interface 300 may be accessed in a browser or mobile application, or otherwise accessed by a software application implemented in a computing device.

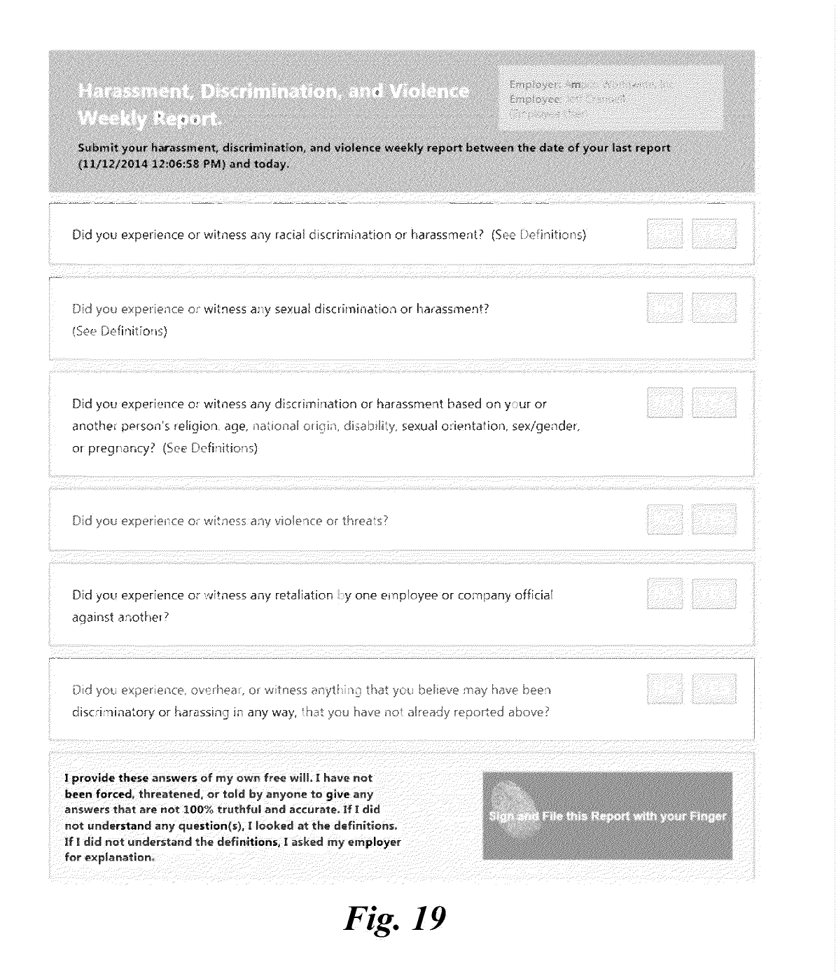

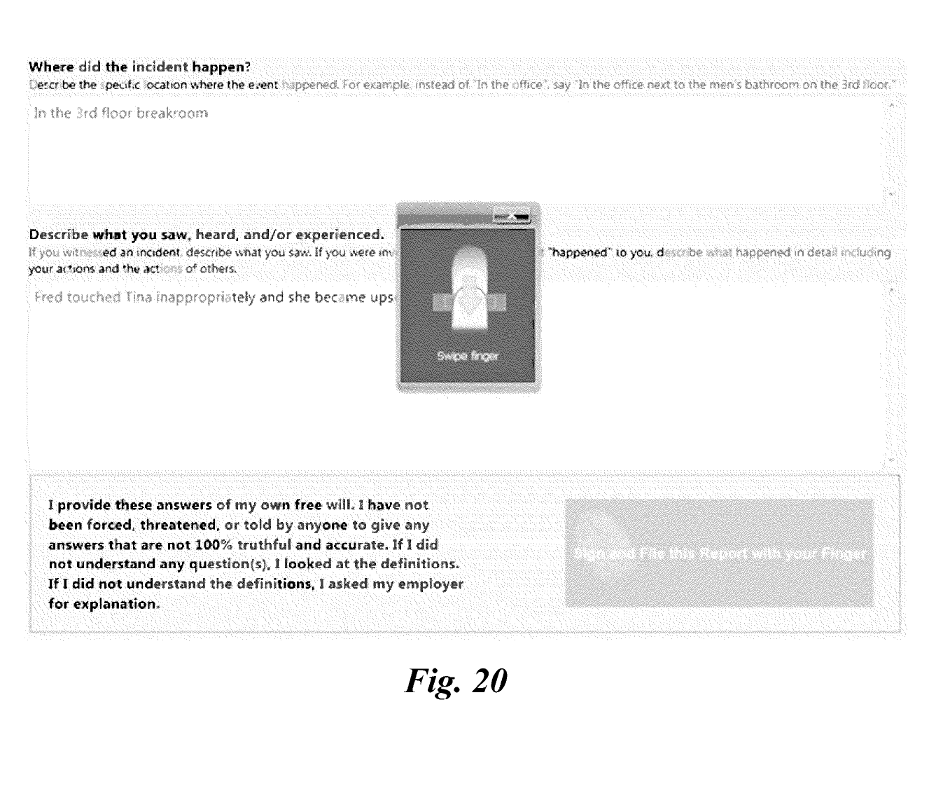

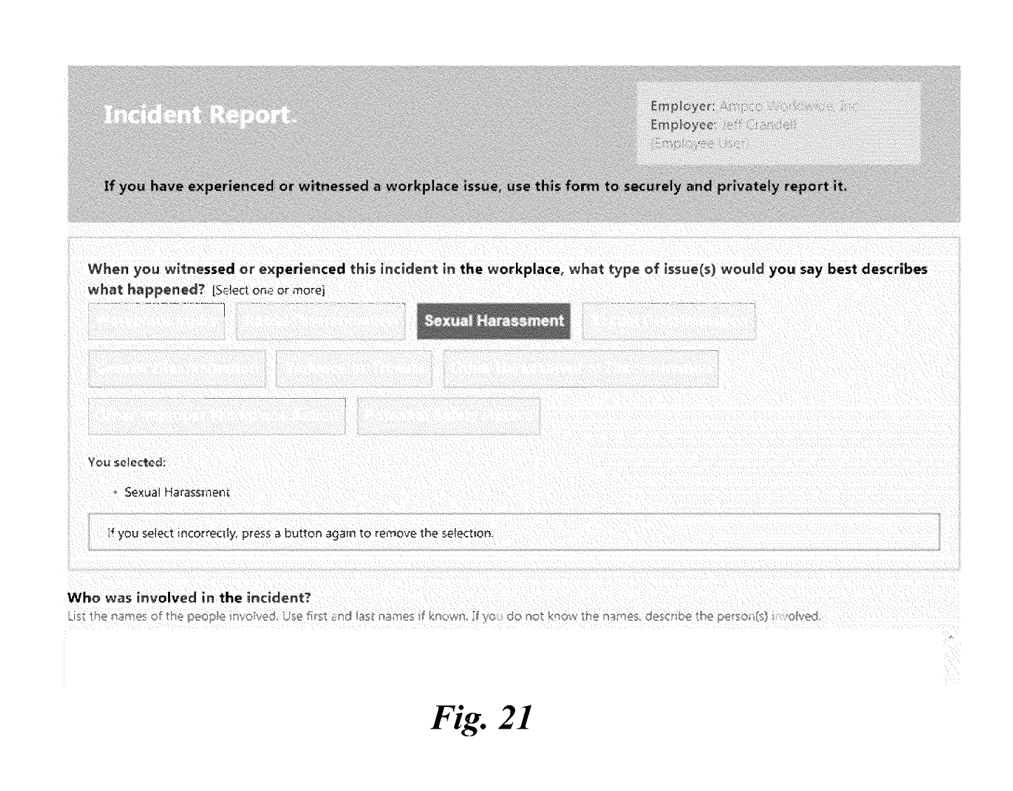

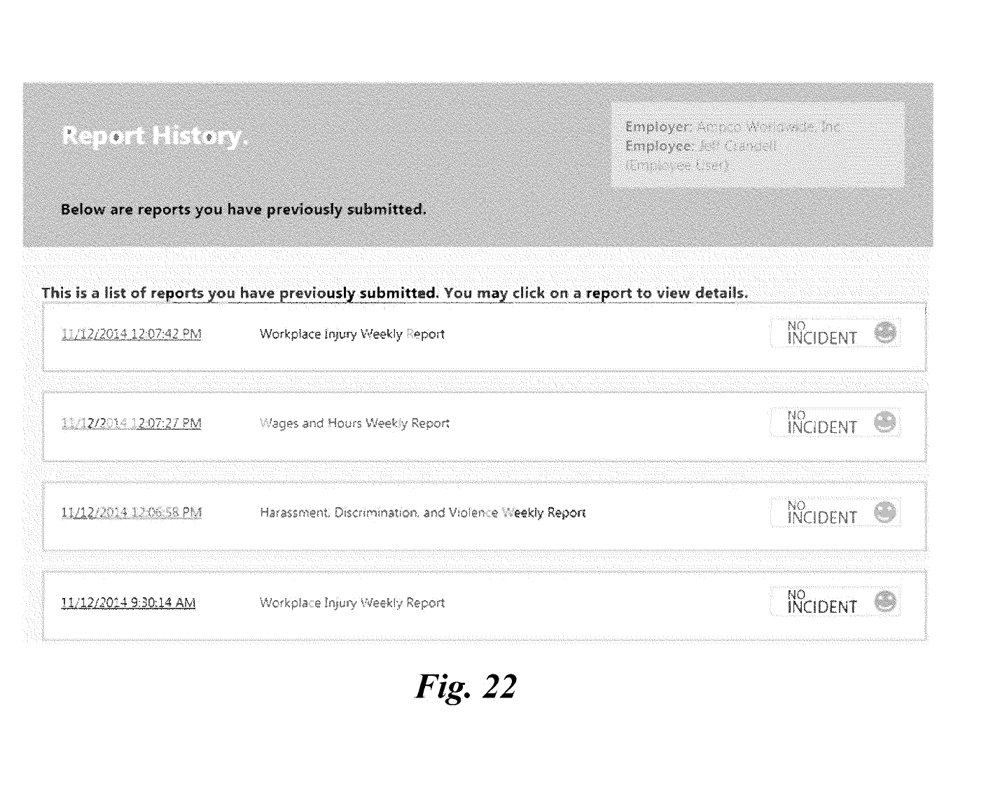

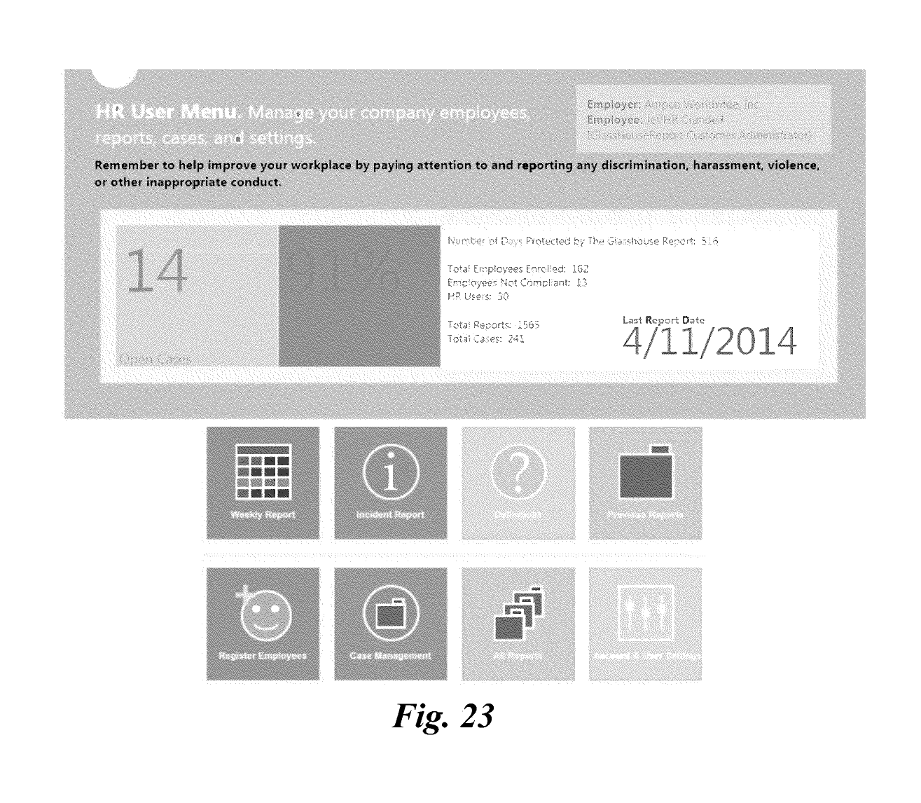

FIG. 19 depicts an example user interface of an example recurring report in which an employee is able to answer questions and file upon completion. FIG. 20 depicts an example user interface that illustrates an employee providing a fingerprint to validate and digitally sign the report of FIG. 19 prior to submission of the report (e.g., to a server of the verification system 22). FIG. 21 depicts an example user interface showing an example of a non-scheduled report which an employee can access at any time as opposed to waiting for a scheduled recurring report. FIG. 22 depicts an example user interface showing a list of reports the employee has previously submitted. FIG. 23 depicts an example user interface with a menu that may be presented to HR role users of the system.

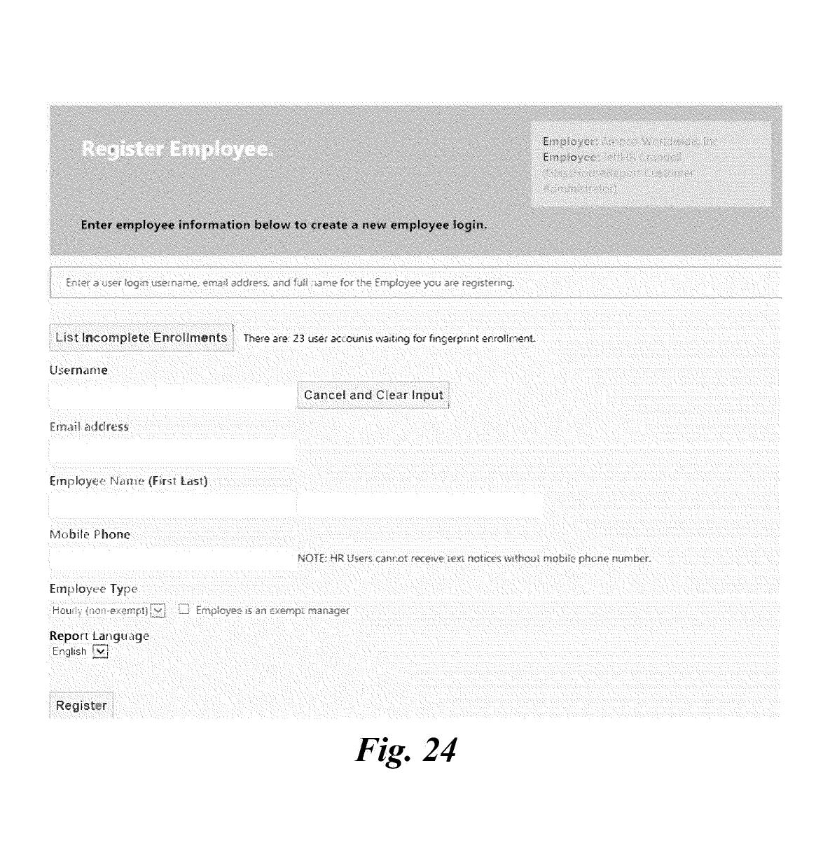

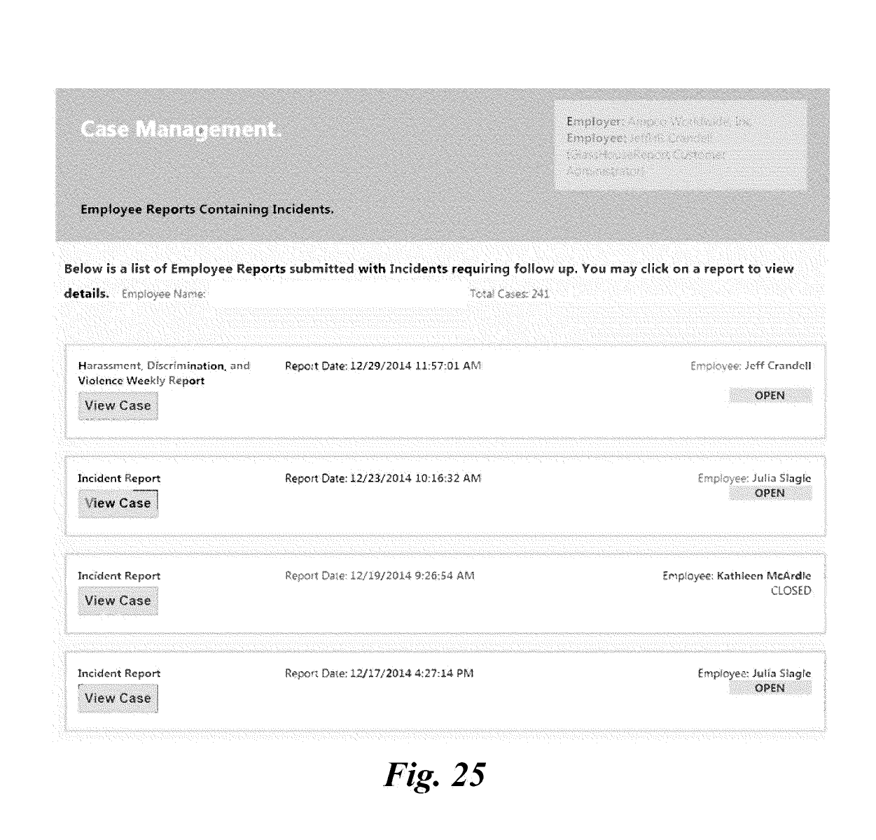

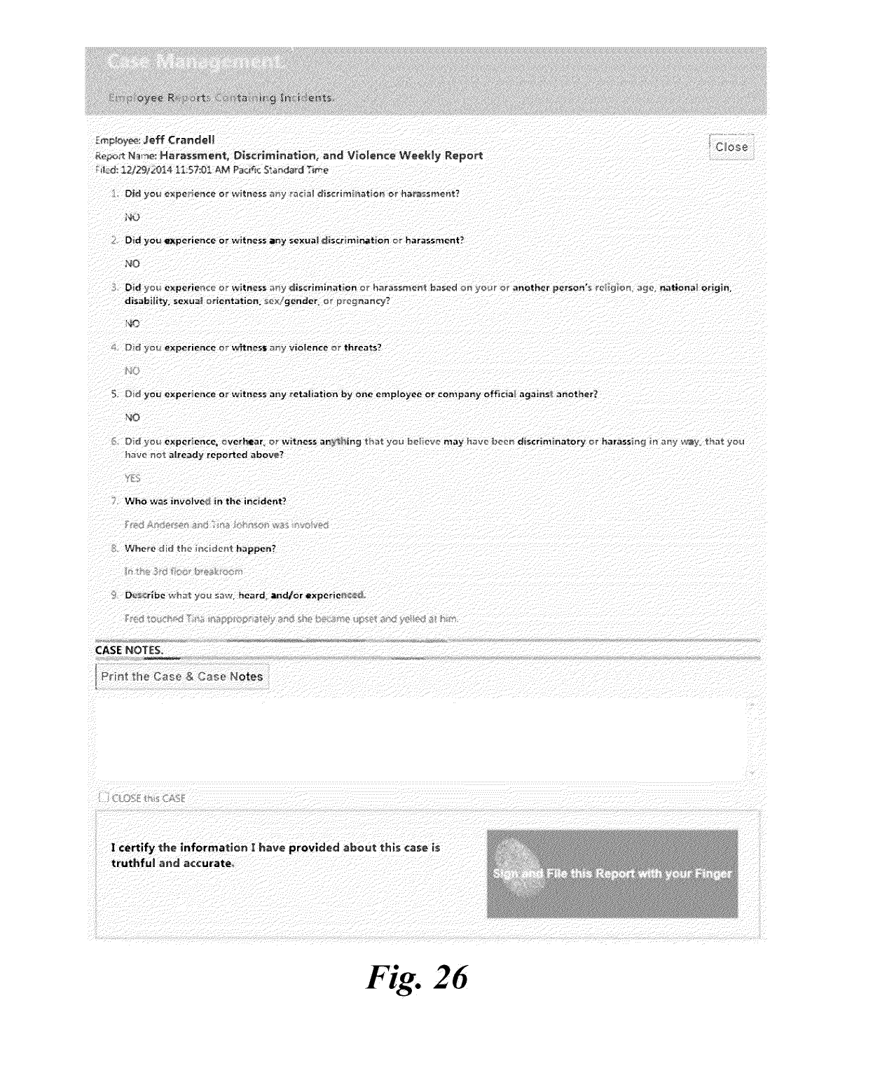

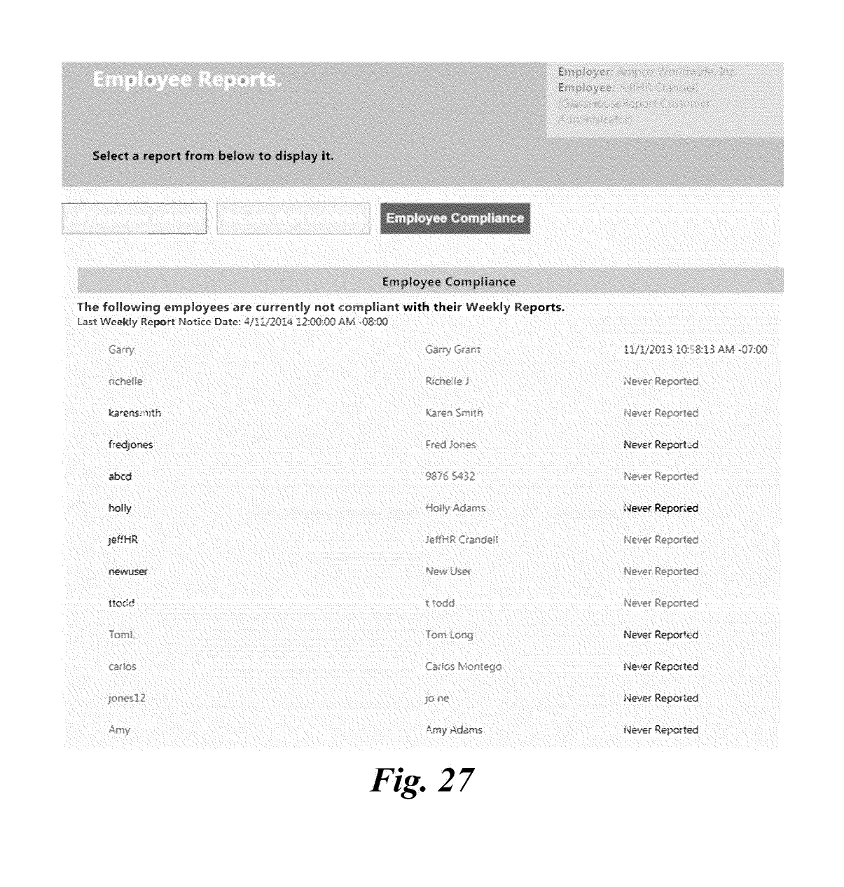

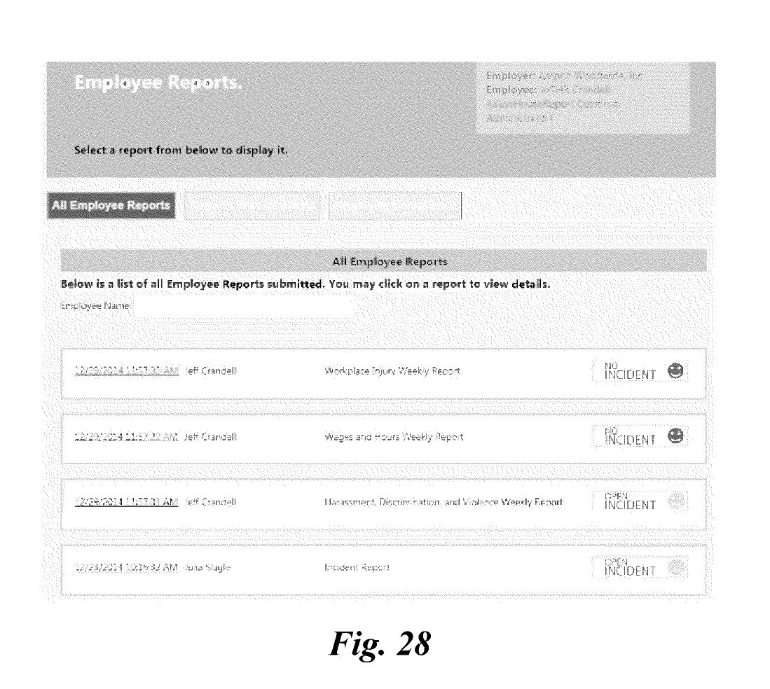

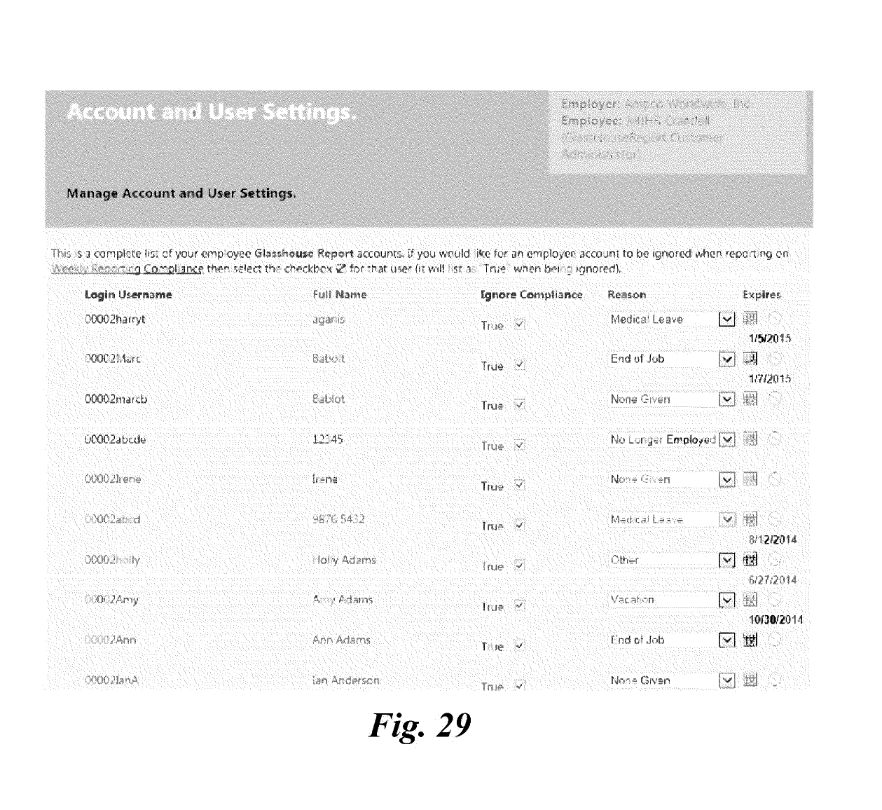

FIG. 24 depicts an example user interface through which HR role users can register new employees into the system and enroll fingerprint templates for users FIG. 25 depicts an example user interface in which HR role users can see cases (which can include reports submitted indicating issues to be addressed) from employees. FIG. 26 depicts an example user interface in which HR role users can review details of a case, which may include the report submitted by an employee. FIG. 26 also depicts functionality for adding case notes to the case as an audit trail of actions taken to address the case. Further, case detail and notes can be printed. Case note updates and printing may require a fingerprint to be inputted. Printing can update the case notes. Case note updates can log the username and time/date of update transaction. FIG. 27 depicts an example user interface displaying to HR role users a non-compliance report of employees who are not compliant with recurring report filing. FIG. 28 depicts an example user interface in which HR role users can review reports submitted from users in their organization. FIG. 29 depicts an example user interface in which HR role users can set compliance requirements to be ignored for any employee optionally along with a reason and automatic expiration date.

### V. Additional Embodiments

In an example implementation, once a week (or at some other frequency) the system's cloud based software automatically emails each employee, requiring them to answer a simple, legally prepared, Yes or No series of questions on: (1) Harassment, Discrimination and Violence, (2) Wage/Hour Issues, (3) Workplace Injury, and/or (4) Safety concerns. Addressing Injury and Safety issues promptly can help control Workers Comp Insurance rates and XMOD scores. If the employee has no incidents to report, and has not witnessed any incidents, answering the questions may take about 60 seconds.

Each employees' “I have not witnessed an incident” report, virtually prevents employees colluding with others to backdate or support false claims. This history can advantageously prevent employees coming back to haunt an employer after being terminated. If an employee reports an incident or safety issue, the system can email and/or text management or HR, allowing them to address the issue and isolate problems or disruptive individuals. This communication can help avert future lawsuits (including class action lawsuits). In an embodiment, all employee reports and their resolutions are stored offsite (from the employer) on the system's secure servers. Nothing remains on the employer's premises in one embodiment. This system can make it difficult or impossible for curious eyes to get into the encrypted files and see, change, erase or rewrite employment history.

If an employer becomes involved with employee litigation, the employer can use the system to retrieve each employee's complete biometrically signed employment history (paper trail) from the system. This biometrically signed, irrefutable, documented information can be a very useful defense and may be invaluable should a conflict arise with the employee (or former employee).

Although this specification refers to employees, any reference to employees herein may be replaced with independent contractors or workers who have no employment relationship, including volunteer workers.

Moreover, although a single report may be presented to an employee, in another embodiment multiple reports are presented to employees. These reports may be presented in a specific order, such as a harassment report followed by a wage and hour report, followed by a managerial duties report, followed by a workplace injuries report. There may be designated series of reports that are presented only to employees of certain classifications. For example, a wave and hour report may be presented only to non-exempt employees, while a managerial report may only be presented to managers. Reports may also be customized based on employee roles or based on individual employee needs to include questions relevant to the employee role or other aspect of the employee.

Further, the system can store a hash of the biometric information with a report and use the hash for validation in the future.

The system described herein can also be implemented together with any combination of the features described in U.S. Pat. No. 8,015,116, titled “Methods for Authentication,” U.S. Pat. No. 8,516,558, titled “Polling Authentication System,” as well as U.S. Publication No. 2009/0300737, titled “Split Template Biometric Verification System,” U.S. Publication No. 2009/0300356, titled “Remote Storage Encryption System,” U.S. Publication No. 2009/0248966, titled “Flash Drive with User Upgradeable Capacity via Removable Flash,” and U.S. Publication No. 2009/0240907, titled “Remote Storage Access Control System.” The disclosures of each of the foregoing patents and publications are hereby incorporated by reference in their entirety.

### VI. Terminology

Conditional language, such as, among others, “can,” “could,” “might,” or “may,” unless specifically stated otherwise, or otherwise understood within the context as used, can be generally intended to convey that certain embodiments include, while other embodiments do not include, certain features, elements and/or steps. Thus, such conditional language can be not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” “include,” “including,” “having,” and the like are to be construed in an inclusive sense, as opposed to an exclusive or exhaustive sense; that can be to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain operations, acts, events, or functions of any of the algorithms described herein can be performed in a different sequence, can be added, merged, or left out altogether (e.g., not all are necessary for the practice of the algorithms). Moreover, in certain embodiments, operations, acts, functions, or events can be performed concurrently, e.g., through multithreaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described herein. Software and other modules may reside and execute on servers, workstations, personal computers, computerized tablets, PDAs, and other computing devices suitable for the purposes described herein. Software and other modules may be accessible via local memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, the processing of the various components of the illustrated systems can be distributed across multiple machines, networks, and other computing resources. In addition, two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks.

These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded onto a computing device or other programmable data processing apparatus to cause a series of operations to be performed on the computing device or other programmable apparatus to produce a computer implemented process such that the instructions which execute on the computer or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the inventions can be modified, if necessary, to employ the inventions, functions, and concepts of the various references described above to provide yet further implementations of the inventions.

These and other changes can be made to the inventions in light of the above Detailed Description. While the above description describes certain examples of the inventions, and describes the best mode contemplated, no matter how detailed the above appears in text, the inventions can be practiced in many ways. Details of the inventions may vary considerably in its specific implementation, while still being encompassed by the inventions disclosed herein. As noted above, particular terminology used when describing certain features or aspects of the inventions should not be taken to imply that the terminology can be being redefined herein to be restricted to any specific characteristics, features, or aspects of the inventions with which that terminology can be associated. In general, the terms used in the following claims should not be construed to limit the inventions to the specific examples disclosed in the specification, unless the above Detailed Description section explicitly defines such terms. Accordingly, the actual scope of the inventions encompasses not only the disclosed examples, but also all equivalent ways of practicing or implementing the inventions under the claims.

To reduce the number of claims, certain aspects of the inventions are presented below in certain claim forms, but the applicant contemplates the various aspects of the inventions in any number of claim forms. For example, while only one aspect of the inventions may be recited as a means-plus-function claim under 35 U.S.C sec. 112(f) (AIA), other aspects may likewise be embodied as a means-plus-function claim, or in other forms, such as being embodied in a computer-readable medium. Any claims intended to be treated under 35 U.S.C. §112(f) will begin with the words “means for”, but use of the term “for” in any other context can be not intended to invoke treatment under 35 U.S.C. §112(f). Accordingly, the applicant reserves the right to pursue additional claims after filing this application, in either this application or in a continuing application.

What is claimed is:

1. A method of providing biometric access, the method comprising:
under control of a hardware processor comprising digital logic circuitry,
receiving biometric information of a user from a biometric sensor;
preprocessing the biometric information to obtain digital biometric data;
comparing the biometric data with a stored biometric template associated with the user to determine whether the biometric data matches the stored biometric template;
in response to determining that the biometric data does not match the stored biometric template, denying access to the user; and
in response to determining that the biometric data does match the stored biometric template,
electronically outputting instructions configured to electronically generate a graphical user interface comprising functionality for the user to respond to one or more queries;
receiving user input from the graphical user interface comprising responses to the one or more queries;
generating a report comprising the responses;
digitally signing the report with a digital certificate associated with the user; and
storing the report and the digital signature in physical computer storage.

2. The method of claim 1, wherein said digitally signing the report further comprises digitally signing the biometric information.

3. The method of claim 1, wherein the biometric information comprises one or more of the following: a fingerprint, a retinal scan, a palm print, audio data, a finger vein scan, a hand vein scan, a signature, typing recognition, gait information, and a DNA sample.

4. The method of claim 1, further comprising receiving the stored biometric template with an embedded browser application.

5. The method of claim 3, further comprising extracting the biometric template from a cookie data structure.

6. The method of claim 1, further comprising encrypting the biometric information with a second encryption despite the biometric information already being encrypted.

7. A biometric access system, the system comprising:
a hardware processor comprising digital logic circuitry configured to:
receive biometric information of a user from a biometric sensor;
compare the biometric data with a stored biometric template associated with the user to determine whether the biometric data matches the stored biometric template;
identify a match between the biometric data and the stored biometric template, and in response to a match being identified:
electronically output a graphical user interface comprising functionality for the user to respond to one or more queries;
receive user input from the graphical user interface comprising responses to the one or more queries;
generate a report comprising the responses; and
store the report in physical computer storage.

8. The system of claim 7, wherein the biometric information comprises one or more of the following: a fingerprint, an iris scan, a palm print, audio data, and a blood vessel scan.

9. The system of claim 7, wherein the hardware processor is further configured to receive the stored biometric template with an embedded browser application.

10. The system of claim 9, wherein the hardware processor is further configured to extract the biometric template from a cookie data structure.

11. The system of claim 7, wherein the hardware processor is further configured to encrypt the biometric information with a second encryption despite the biometric information already being encrypted.

12. The system of claim 7, wherein the hardware processor is further configured to digitally sign the report.

13. The system of claim 12, wherein the hardware processor is further configured to digitally sign the report together with the biometric information.

14. Non-transitory physical computer storage comprising instructions stored thereon that, when executed by a hardware processor, are configured to implement a biometric access system configured to:
receive an indication of whether biometric information of a user matches a stored biometric template, and in response,
electronically output a graphical user interface comprising functionality for the user to respond to one or more queries;
receive user input from the graphical user interface comprising responses to the one or more queries;
generate a report comprising the responses; and
store the report in physical computer storage.

15. The non-transitory physical computer storage of claim 14, wherein the biometric information comprises one or more of the following: a fingerprint, an iris scan, a palm print, audio data, and a blood vessel scan.

16. The non-transitory physical computer storage of claim 14, wherein the system is further configured to receive the stored biometric template with an embedded browser application.

17. The non-transitory physical computer storage of claim 16, wherein the system is further configured to extract the biometric template from a cookie data structure.

18. The non-transitory physical computer storage of claim 14, wherein the system is further configured to encrypt the biometric information with a second encryption despite the biometric information already being encrypted.

19. The non-transitory physical computer storage of claim 14, wherein the system is further configured to digitally sign the report.

20. The non-transitory physical computer storage of claim 18, wherein the system is further configured to digitally sign the report together with the biometric information.
